(19) United States
(12) Patent Application Publication
(10) Pub. No.: US 2025/0027178 A1
(43) Pub. Date: Jan. 23, 2025

(54) FACILITY FOR PRODUCING REDUCED IRON AND METHOD FOR PRODUCING REDUCED IRON

(71) Applicant: NIPPON STEEL CORPORATION, Tokyo (JP)

(72) Inventors: Shoji USHIO, Tokyo (JP); Kimihito SUZUKI, Tokyo (JP); Takashi IIJIMA, Tokyo (JP)

(73) Assignee: NIPPON STEEL CORPORATION, Tokyo (JP)

(21) Appl. No.: 18/714,122

(22) PCT Filed: Nov. 30, 2022
(86) PCT No.: PCT/JP2022/044198

§ 371 Date: May 29, 2024

(30) Foreign Application Priority Data
Nov. 30, 2021 (JP) 2021-194494

(51) Int. Cl. C21B 13/00

(52) U.S. Cl. CPC C21B 13/0033; C21B 2200/00

(57) ABSTRACT

A facility for producing reduced iron includes: a granulation apparatus that granulates raw material fine powder that contains iron and has a median diameter of 50 μm or less into granular powder in a fluidized bed formed by fluidizing medium particles that do not thermally decompose during fluidization; and a reduction apparatus that reduces at least the granular powder in the fluidized bed formed by fluidizing the granular powder.

### TECHNICAL FIELD OF THE INVENTION

The present invention relates to a facility for producing reduced iron and a method for producing reduced iron. Priority is claimed on Japanese Patent Application No. 2021-194494, filed Nov. 30, 2021, the content of which is incorporated herein by reference.

### BACKGROUND ART

In recent years, there has been a decrease in the availability of raw materials for high-grade iron ore having a particle size that is easy to handle and having a small amount of gangue components. Therefore, there is a demand for a method for performing a reduction process on fine powder ore having a particle size decreased due to the removal of gangue through beneficiation and powdered iron ore having inferior quality due to a large amount of gangue components and having a wide particle size range including ore with a fine particle size.

Examples of a method for producing reduced iron by reducing the fine powder ore or powdered iron ore as described above include a method of allowing these ores to agglomerate into pellets or the like and reducing the pellets or the like in a shaft furnace, and a method of allowing the fine powder ore or powdered iron ore to react with a reducing gas without agglomeration of the fine powder ore or powdered iron ore. Examples of the latter include a method in which a fluidized bed is used.

A fluidized bed is a layer in which a powder is blown up in a vessel by a fluid such as a gas and enters a floating and suspended state, so that the powder is in a fluidized state. Since the powder that forms the fluidized bed has a large specific surface area per unit volume, the fluidized bed is applied to a chemical reaction, heat exchange, or the like. The cost required for the reduction of iron ore using the shaft furnace is high because of the cost required for pelletization. Therefore, there is a possibility that a method using a fluidized bed that does not require pelletization of powdered iron ore in an iron-making process for obtaining reduced iron from the powdered iron ore is very advantageous in terms of cost. On the other hand, in the reduction method using the fluidized bed, there are cases where particles of the powdered iron ore adhere to each other in a reduction process, leading to blockage of an inside of a processing vessel. Therefore, in a case of using the fluidized bed, it is important to find an operation method that can reach a predetermined reduction degree while preventing the adhesion of powdered iron ore during the reduction process.

Typically, when processing a powder in a fluidized bed, a flow velocity of a gas supplied into a vessel is set according to a specific gravity and a particle size of the target powder, and a fluidized bed is realized in the processing vessel at a flow velocity equal to or faster than a minimum gas flow velocity (minimum fluidization velocity) required for the powder to enter a fluidized state.

As an iron-making process for obtaining reduced iron, there are numerous reported examples of a reduction technology using a fluidized bed for powdered iron ore.

For example, Non-Patent Document 1 discloses a process of reduced iron ore powder having a particle size of 0.1 to 2.0 mm with hydrogen gas using a fluidized bed. In this process, fine powder having a particle size as small as less than 0.1 mm cannot be processed. Therefore, iron ore powder and dust having a particle size of less than 0.1 mm are mixed with a binder or other granulation aids in a mixer and then granulated to a size that can be processed.

Non-Patent Document 2 describes a processing method using a particulate fluidized bed, in which, in order to reduce converter dust, which contains wüstite (Fe₁₋ₓO) and is a hardly fluidizable fine powder, fluidizable medium particles having a larger particle size than the converter dust are fluidized to cause the converter dust to be introduced into a single-stage fluidized bed.

Patent Document 1 discloses a method for producing a briquette containing particulate iron. In this method, particulate iron ore of 0.005 mm to 12 mm is reduced in a fluidized bed.

Patent Document 2 discloses a step of directly reducing a metal-containing material containing micron-sized particles, the step including: supplying the metal-containing material, a solid carbonaceous material, an oxygen-containing gas, and a fluidizing gas to a fluidized bed in a fluidized bed vessel and maintaining the fluidized bed in the fluidized bed vessel; at least partially reducing the metal-containing material in the fluidized bed vessel; and discharging a product stream containing the at least partially reduced metal-containing material from the fluidized bed vessel, in which
(a) a carbon-rich zone in the fluidized bed is established and maintained,
(b) the metal-containing material containing a metallized material is passed through the carbon-rich zone, and
(c) the oxygen-containing gas is injected into the carbon-rich zone to oxidize the metallized material, the solid carbonaceous material, and other oxidizable solids and gases, thereby inducing controlled agglomeration of the particles, in the step of directly reducing the metal-containing material.

Patent Document 3 discloses a smelting reduction method in which fine iron ore is charged into a three-stage fluidized bed reactor, a reducing gas is supplied to reduce the charged fine iron ore to produce sponge iron, and the sponge iron is then charged into a melting gasifier to produce molten pig iron. In the technique described in Patent Document 3, exhaust gas discharged from the melting gasifier is separated into reducing gas and dust. The separated reducing gas is supplied to a lower portion of a final fluidized bed reactor, and dust having small particles among the separated dust is supplied to a portion of the final fluidized bed reactor above a distributor to coat the fine iron ore fluidized in each fluidized bed reactor, thereby preventing mutual adhesion of the fine iron ore and adhesion thereof to the distributor.

### PRIOR ART DOCUMENT

### Patent Document

[Patent Document 1] PCT International Publication No. WO2011/107349
[Patent Document 2] PCT International Publication No. WO2005/116274
[Patent Document 3] PCT International Publication No. WO01/046478

### Non-Patent Document

[Non-Patent Document 1] D. Nuber, H. Eichberger and B. Rollinger “Circored fine ore direct reduction”, Millennium Steel, (2006), 37.
[Non-Patent Document 2] Takayuki Takarada et al., and six others, “Reduction of Iron Oxide Fine Particles from a Converter in a Powder-Particle Fluidized Bed”, KAGAKU KOGAKU RONBUNSHU, Volume 19, Issue 3, (1993), p. 505-510

### DISCLOSURE OF THE INVENTION

### Problems to be Solved by the Invention

As in the related art described above, the fluidized bed is not a reduction processing method suitable for all particle size ranges of powdered iron ore. In many processes, a gas flow velocity is selected to matched to a particle size of a main powdered iron ore. However, the gas flow velocity is often too fast for fine powder ore having a smaller particle size contained in the powdered iron ore. Therefore, such fine powder ore is generally blown out of the processing vessel. In addition, particles having a very small particle size have high adhesion. This can result in a phenomenon called channeling, which is a bypass phenomenon of a gas in a powder layer during gas flow, and there are cases where it becomes difficult to realize a uniform fluidized state.

In addition, even in a circulating fluidized bed (CFB) in which a gas flow velocity is increased to circulate a powder along with a gas, the powder having an excessively small particle size tends to be discharged to the outside of the system along with the gas. Iron ore having a general specific gravity exhibits a hardly fluidizable property at particle sizes of about 20 to 30 μm as classified in the Geldart's diagram of fluidization types. Therefore, iron ore having such a fine particle size is usually excluded from processing in a fluidized bed. Furthermore, an adhesion force F, which is attributed to the van der Waals force simply acting on particles, is proportional to a particle diameter dₚ. On the other hand, a separation force between the particles is proportional to a self-weight W of the particles, and W is proportional to ρdₚ³, where a contribution of the particle size dₚ is larger than a true density p of the particles. Based on these relationships, generally, for many particles, the adhesion force and the separation force due to the self-weight are balanced at a particle size of 50 to 100 μm as a boundary, and particles having a particle size smaller than this region have a relatively large adhesion force, leading to a possibility of problems such as agglomeration between particles, adhesion to wall surface materials, and blockage.

In the technique described in Non-Patent Document 1, larger granules are formed using the fine powder ore and the binder for fluidization of the powder. However, in order to prevent disintegration due to collisions between the granules in the fluidized bed, crushing strength of the granules is increased. Therefore, in the technique described in Non-Patent Document 1, energy and cost are required for a granulation process and a process for increasing the crushing strength of the granules.

In the technique described in Non-Patent Document 2, fine iron oxide particles having a diameter of submicron to several tens of μm and having a hardly fluidizable property are fluidized together with the medium particles using the medium particles. However, in order to prevent agglomeration of the fine iron oxide particles, a gas flow velocity is increased to cause fine reduced iron to fly away from the fluidized bed. In this method, it is necessary to secure a residence time in the fluidized bed such that reduction sufficiently progresses in a process in which the fine iron oxide flies away. However, since particles having a smaller particle size have a shorter residence time, in a case where particles to be processed are not limited to the converter dust targeted in Non-Patent Document 2, controlling the particles is not easy. Therefore, in the technique described in Non-Patent Document 2, the particle size of the target iron oxide particles is submicron to several tens of μm, and it is difficult to deal with ore powder having a wider particle size distribution without being limited to the converter dust.

In the technique described in Patent Document 1, an iron content in the briquette decreases when the reduction of fine powder is insufficient. In a case where such a briquette is used as a raw material for steelmaking, a steelmaking cost increases. Fine powder has a small particle size and the reduction reaction thereof progresses more easily, while fine powder tends to be quickly discharged from a reaction vessel where the reduction progresses. Therefore, there are cases where the reduction thereof becomes insufficient, and there is a concern that this leads to a decrease in an iron content of a briquetted product reduced iron.

In the technique described in Patent Document 2, a solid matter delivery device such as a solid matter injection lance is required to prepare the carbon-rich zone in the fluidized bed, which makes the device more complex, leading to an increase in cost.

The technique described in Patent Document 3 states that the dust that has been separated and recovered and insufficiently reduced is introduced into the fluidized bed to coat metallic iron particles with the dust, thereby preventing adhesion between the metallic iron particles. However, there is a possibility that the introduced dust flies away from the fluidized bed by the gas before being adhered to the metallic iron particles, and thus there is a possibility that the adhesion between the metallic iron particles cannot be prevented.

The present invention has been made in view of the above-described problems, and an object of the present invention is to provide a facility for producing reduced iron and a method for producing reduced iron capable of reducing a fine powder ore at a high yield and a low cost by using a fluidized bed.

### Means for Solving the Problem

Fine powder ore having a fine particle size that is hardly fluidizable has high adhesion, and fine powder in which reduction has progressed partially, such as magnetite (Fe₃O₄) or wüstite (Fe₁₋ₓO), is highly reoxidizable. Due to heat generation caused by the reoxidation, sintering occurs and the fine powder easily agglomerates. In addition, in a reduction process of iron ore using a fluidized bed, in a case where the iron ore is fine powder, when metallic iron appears on surface layers of particles of the powder along with the reduction, the particles are likely to agglomerate due to adhesion (sticking) between the particles. The present inventors focused on these points, and conceived an idea of positively using an agglomeration phenomenon, which is avoided in an iron-making process using a fluidized bed in the related art, to self-granulate hardly fluidizable fine powder ore into iron ore having a size that is easy to handle. Specifically, the present inventors conceived an idea of agglomerating fine powder ore in a fluidized bed to be granulated into a particle size that is easily fluidized and then introducing granular powder into a reduction process using a fluidized bed. However, as has hitherto been a problem, fluidization of powder made of hardly fluidizable fine powder ore is difficult. In addition, when the agglomeration phenomenon progresses, clogging or blockage occurs in an inside of a granulation vessel. According to an examination conducted by the present inventors, it was found that by charging coarse particles as a fluidizing medium to assist in the formation of a fluidized bed in a granulation vessel, fine powder ore can be agglomerated in the fluidized bed formed by the coarse particles while being fluidized to an extent that clogging or blockage does not occur. There has been no report of a technique conceived by the present inventors, in which fine iron ore having a particle size that exhibits a hardly fluidizable property is granulated into a size that is easily fluidized while being fluidized, for application in a reduced iron production process. Furthermore, it was found that fine powder ore can be reduced in a fluidized bed at a high yield by using agglomerates (granular powder).

The gist of the present invention completed based on the above findings is as follows.

[1] A facility for producing reduced iron according to an aspect of the present invention includes: a granulation apparatus that granulates raw material fine powder that contains iron and has a median diameter of 50 μm or less into granular powder in a fluidized bed formed by fluidizing medium particles that do not thermally decompose during fluidization; and a reduction apparatus that reduces at least the granular powder in a fluidized bed formed by fluidizing the granular powder.

[2] In the facility for producing reduced iron according to [1], the reduction apparatus may include one or more circulating fluidized bed reduction apparatuses for forming a circulating fluidized bed or one or more bubbling fluidized bed reduction apparatuses for forming a bubbling fluidized bed or combination thereof.

[3] In the facility for producing reduced iron according to [1] or [2], the reduction apparatus may include a collecting device that collects dust including at least fine particles of partially unreduced iron ore.

[4] In the facility for producing reduced iron according to [3], the reduction apparatus may include a feeding device that feeds the dust collected by the collecting device to a granulation vessel of the granulation apparatus.

[5] In the facility for producing reduced iron according to any one of [1] to [4], the medium particles included in the granulation apparatus may include a carbide, an oxide, a nitride, or any combination thereof having a melting point of higher than 1,200° C.

[6] In the facility for producing reduced iron according to any one of [1] to [5], the granulation apparatus may include a mechanism for measuring a pressure loss in the fluidized bed.

[7] In the facility for producing reduced iron according to any one of [1] to [6], the granulation apparatus may include a granular powder separation device that separates the granular powder from the fluidized bed, and the granular powder separation device may include a mechanism of magnetic separation, dry sieving, pneumatic classification, or sedimentation classification, or any combination thereof.

[8] In the facility for producing reduced iron according to any one of [1] to [7], in a granulation vessel in which the fluidized bed is formed, a maximum cross-sectional area of a horizontal cross section in a freeboard portion provided above the fluidized bed of the granulation vessel may be larger than a cross-sectional area of a horizontal cross section in a region in which the fluidized bed is disposed.

[9] In the facility for producing reduced iron according to any one of [1] to [8], in a granulation vessel in which the fluidized bed is formed, a maximum cross-sectional area of a horizontal cross section in a freeboard portion provided above the fluidized bed may be larger than a cross-sectional area at which a gas superficial velocity in the freeboard portion becomes a terminal velocity of the raw material fine powder.

[10] In the facility for producing reduced iron according to any one of [1] to [9], the reduction apparatus may include a pipe for supplying the granular powder to an inside of the reduction apparatus, and the reduction apparatus and the granulation apparatus may be connected to each other by the pipe.

[11] A method for producing reduced iron according to another aspect of the present invention includes: a granulation process of granulating raw material fine powder that contains iron and has a median diameter of 50 μm or less into granular powder in a fluidized bed formed by fluidizing medium particles that do not thermally decompose during fluidization; and a reduction process of reducing at least the granular powder in a fluidized bed formed by fluidizing the granular powder.

[12] In the method for producing reduced iron according to [11], in the reduction process, one or more circulating fluidized bed reaction vessels, one or more bubbling fluidized bed reaction vessels, or one or more circulating fluidized bed reaction vessels and one or more bubbling fluidized bed reaction vessels may be used.

[13] In the method for producing reduced iron according to or [12], in the reduction process, dust including at least fine particles of partially unreduced iron ore may be collected.

[14] In the method for producing reduced iron according to [13], the dust collected in the reduction process may be used in the granulation process.

[15] In the method for producing reduced iron according to any one of to [14], the medium particles used in the granulation process may include a carbide, an oxide, a nitride, or any combination thereof having a melting point of higher than 1,200° C.

[16] In the method for producing reduced iron according to any one of to [15], in the granulation process, a pressure loss in the fluidized bed may be measured.

[17] In the method for producing reduced iron according to any one of to [16], in the granulation process, the granular powder may be separated from the fluidized bed, and the separation of the granular powder may be performed by magnetic separation, dry sieving, pneumatic classification, or sedimentation classification, or any combination thereof.

[18] In the method for producing reduced iron according to any one of to [17], in a granulation vessel in which the fluidized bed is formed, a maximum cross-sectional area of a horizontal cross section in a freeboard portion provided above the fluidized bed of the granulation vessel may be larger than a cross-sectional area of a horizontal cross section in a region in which the fluidized bed is disposed.

[19] In the method for producing reduced iron according to any one of to [18], a maximum cross-sectional area of a horizontal cross section in a freeboard portion provided above the fluidized bed formed in the granulation process may be larger than a cross-sectional area at which a gas superficial velocity in the freeboard portion becomes a terminal velocity of the raw material fine powder.

[20] In the method for producing reduced iron according to any one of to [19], a granulation apparatus that granulates the raw material fine powder that contains iron and has a median diameter of 50 μm or less into the granular powder in the fluidized bed formed by fluidizing the medium particles that do not thermally decompose during fluidization and a reduction apparatus that reduces the granular powder may be connected to each other, and the granular powder may be supplied to the reduction apparatus via a pipe provided in the reduction apparatus.

### Effects of the Invention

According to the present invention, fine powder ore can be reduced at a high yield and at a low cost by using a fluidized bed.

### BRIEF DESCRIPTION OF THE DRAWINGS

FIG. 1 is a diagram showing an example of a granulation apparatus provided in a facility for producing reduced iron according to an embodiment of the present invention.

FIG. 2 is a diagram showing a modification example of the granulation apparatus in the embodiment.

FIG. 3 is a diagram showing a modification example of the granulation apparatus in the embodiment.

FIG. 4 is a diagram showing a modification example of the granulation apparatus in the embodiment.

FIG. 5 is a diagram showing a modification example of the granulation apparatus in the embodiment.

FIG. 6 is a schematic diagram for describing an example of a transporting device in the embodiment.

FIG. 7 is a schematic diagram for describing another example of the transporting device in the embodiment.

FIG. 8 is a schematic diagram for describing another example of the transporting device in the embodiment.

FIG. 9 is a schematic diagram for describing another example of a pressure measuring device in the embodiment.

FIG. 10 is a schematic diagram for describing an example of feeding of raw material fine powder in the embodiment.

FIG. 11 is a schematic diagram for describing another example of the feeding of the raw material fine powder in the embodiment.

FIG. 12 is a schematic diagram for describing another example of the feeding of the raw material fine powder in the embodiment.

FIG. 13 is a schematic diagram for describing another example of a distributor in the embodiment.

FIG. 14 is a schematic diagram of a circulating fluidized bed reduction apparatus with which a reduction apparatus in the embodiment can be configured.

FIG. 15 is a schematic diagram for describing a bubbling fluidized bed.

FIG. 16 is a schematic diagram of a bubbling fluidized bed reduction apparatus with which the reduction apparatus in the embodiment can be configured.

FIG. 17 is a schematic diagram showing another example of a reactor of the bubbling fluidized bed reduction apparatus in the embodiment.

FIG. 18 is a schematic configuration diagram showing an example of the facility for producing reduced iron provided with one circulating fluidized bed reduction apparatus as the reduction apparatus.

FIG. 19 is a schematic configuration diagram showing an example of the facility for producing reduced iron provided with one bubbling fluidized bed reduction apparatus as the reduction apparatus.

FIG. 20 is a schematic configuration diagram showing an example of the facility for producing reduced iron provided with one circulating fluidized bed reduction apparatus and three bubbling fluidized bed reduction apparatuses as the reduction apparatus.

FIG. 21 is a schematic configuration diagram showing an example of the facility for producing reduced iron provided with one circulating fluidized bed reduction apparatus and one bubbling fluidized bed reduction apparatus as the reduction apparatus.

### EMBODIMENTS OF THE INVENTION

Hereinafter, preferred embodiments of the present invention will be described in detail with reference to the drawings. In the present specification and the drawings, like constituent elements having substantially the same functional configuration are denoted by like reference numerals, and overlapping description will be omitted. Furthermore, ratios and dimensions of the respective constituent elements in the drawings do not represent actual ratios and dimensions of the respective constituent elements.

A method for producing reduced iron according to the present embodiment includes: a granulation process of granulating raw material fine powder that contains iron and has a median diameter of 50 μm or less into granular powder in a fluidized bed formed by fluidizing medium particles that do not thermally decompose during fluidization; and a reduction process of reducing at least the granular powder in the fluidized bed formed by fluidizing the granular powder. In the granulation process, for example, a granulation apparatus 10 described below is used, and in the reduction process, a reduction apparatus 20 is used. Hereinafter, the granulation apparatus 10 and the reduction apparatus 20 will be described.

### <Granulation Apparatus 10>

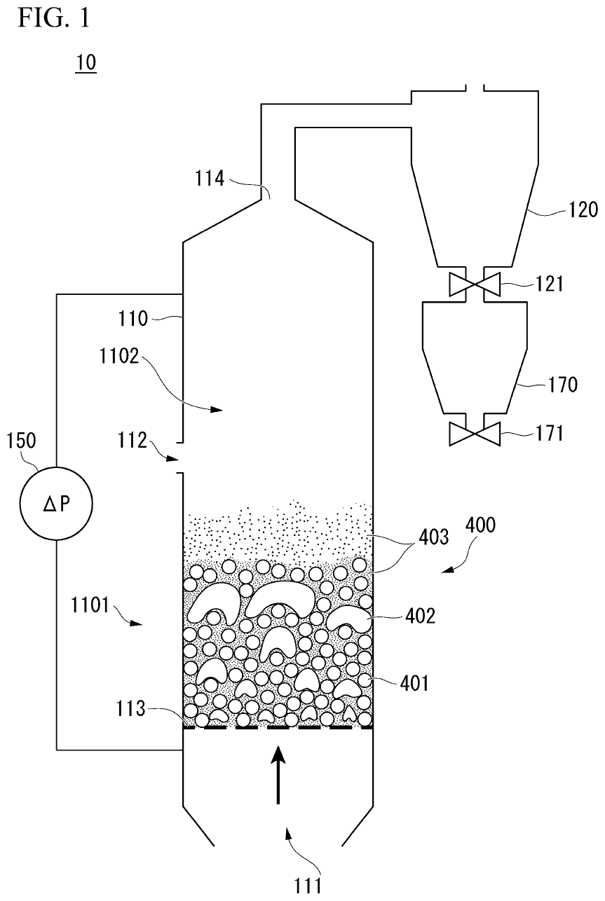

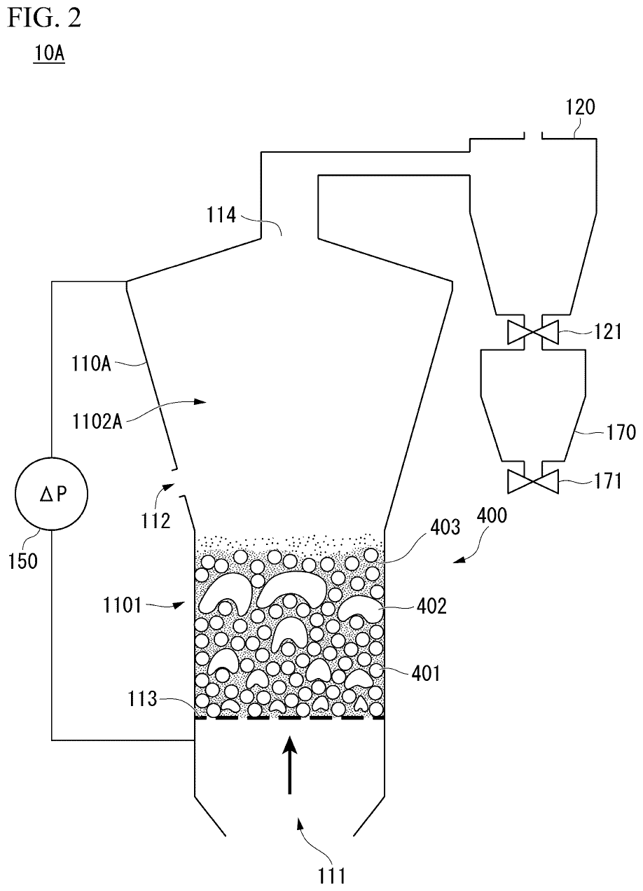

The granulation apparatus 10 will be described with reference to FIGS. 1 and 2. FIG. 1 is a diagram showing an example of a granulation apparatus provided in a facility for producing reduced iron according to an embodiment of the present invention. FIGS. 2 to 5 are diagrams showing modification examples of the granulation apparatus in the present embodiment. The granulation apparatus 10 forms a particulate fluidized bed (PFB) 400. The granulation apparatus 10 includes, for example, a granulation vessel 110 and a dry dust collector 120, as shown in FIG. 1. The granulation apparatus 10 may include a vessel 170 as appropriate.

### [Granulation Vessel 110]

The granulation vessel 110 includes a gas supply port 111 for a fluidizing gas (supply gas) disposed at a bottom portion thereof, a raw material fine powder supply port 112 through which raw material fine powder 403 is supplied to an inside of the granulation vessel 110, a distributor 113 which is disposed above the gas supply port 111 and has a plurality of vent holes to rectify a flow of a gas, and an outlet 114 which is an outlet of the gas inside the granulation vessel 110. Medium particles 401 having a particle size larger than that of the raw material fine powder 403 are charged onto the distributor 113 inside the granulation vessel 110.

The granulation vessel 110 has a region 1101 in which the particulate fluidized bed 400 is disposed, and a freeboard portion 1102 provided above the particulate fluidized bed 400 of the granulation vessel 110. In the freeboard portion 1102, the raw material fine powder 403 jumping out of the particulate fluidized bed 400 or the granular powder obtained by granulating the raw material fine powder 403 may be present depending on a flow velocity of the supply gas.

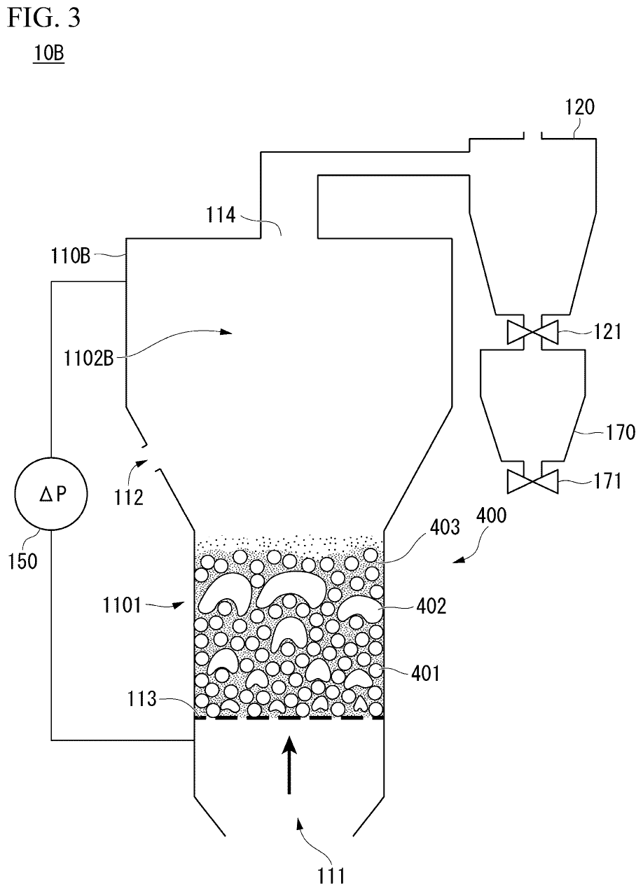

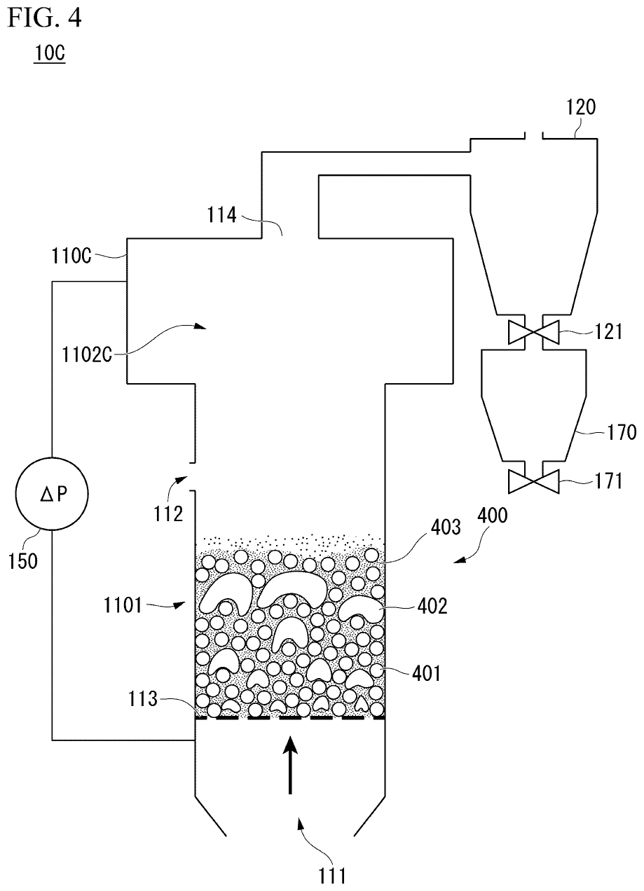

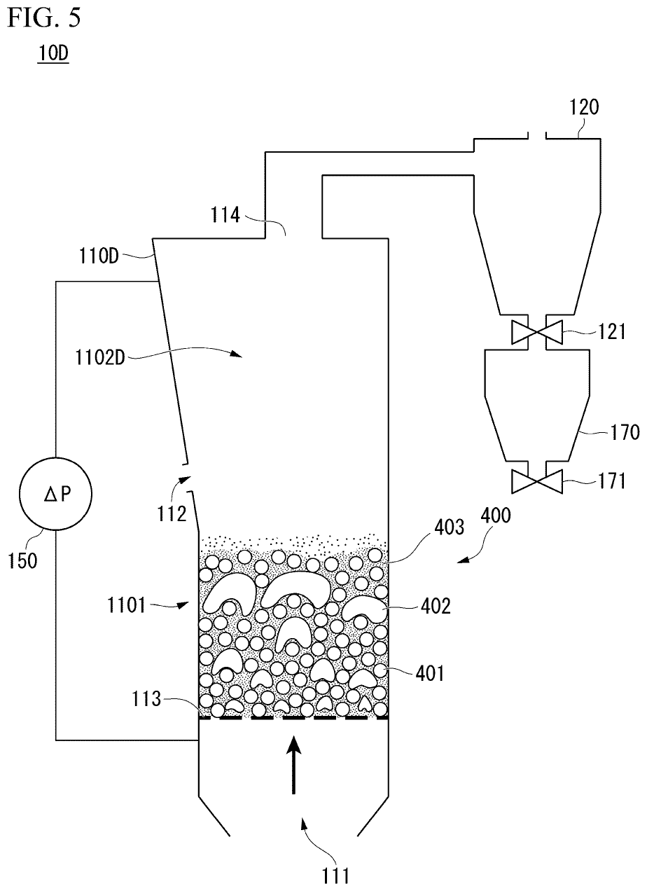

A granulation vessel 110A in a granulation apparatus 10A, which is a modification example of the granulation apparatus 10, is configured so that, as shown in FIG. 2, a maximum cross-sectional area of a horizontal cross section in a freeboard portion 1102A provided above the particulate fluidized bed 400 of the granulation vessel 110A is larger than a cross-sectional area of a horizontal cross section in the region 1101 in which the particulate fluidized bed 400 is disposed. In such a case, a gas flow velocity decreases in an upper portion in the granulation vessel 110A, and even if the raw material fine powder 403 in a non-granulated state is blown up from the particulate fluidized bed 400, flying of the raw material fine powder 403 out of the granulation vessel 110A from the outlet 114 is suppressed, allowing the raw material fine powder 403 to fall and return to the inside of the particulate fluidized bed 400. Therefore, it is preferable that in the granulation vessel, the maximum cross-sectional area of the horizontal cross section in the freeboard portion provided above the fluidized bed of the granulation vessel is larger than the cross-sectional area of the horizontal cross section in the region in which the fluidized bed is disposed. Examples of the granulation vessel having such a freeboard portion are shown in FIGS. 2 to 5. For example, as shown in FIG. 2, the freeboard portion 1102A has a tapered shape in which a cross-sectional area of the horizontal cross section increases toward an upper side. In addition, as shown in FIG. 3, a freeboard portion 1102B has a tapered shape up to an intermediate point and a straight body shape having a constant cross-sectional area on the tapered shape. In addition, as shown in FIG. 4, a freeboard portion 1102C has a shape in which cross-sectional areas of horizontal cross sections in a lower part and an upper part thereof are different from each other, and the cross-sectional area of the upper part is larger than the cross-sectional area of the lower part. In addition, as shown in FIG. 5, a freeboard portion 1102D has a shape in which, in a front view, one side extends vertically, the other side extends at an inclination with respect to a vertical direction, and a cross-sectional area of a horizontal cross section increases upward. The freeboard portions 1102A, 1102B, 1102C, and 1102D shown in FIGS. 2 to 5 are merely examples of freeboard portions that are configured to have a maximum cross-sectional area of a horizontal cross section larger than the cross-sectional area of the horizontal cross section of the region 1101 in the granulation vessel 110. A shape of the freeboard portion in which the maximum cross-sectional area of the horizontal cross section is larger than the cross-sectional area of the horizontal cross section of the region 1101 in the granulation vessel 110 may be a combination of the shapes shown in FIGS. 2 to 5 or a shape other than the shapes shown in FIGS. 2 to 5.

Furthermore, it is preferable that the maximum cross-sectional area of the horizontal cross section in each of the freeboard portions 1102, 1102A, 1102B, 1102C, and 1102D is larger than a cross-sectional area at which a superficial velocity of the gas in the freeboard portion becomes a terminal velocity of the raw material fine powder 403. Depending on the cross-sectional area of the horizontal cross section in the freeboard portion, the flow velocity of the supply gas, a density of the supply gas, a particle size of the raw material fine powder 403, and a particle density of the raw material fine powder 403, the superficial velocity of the gas in the freeboard portion may be faster than the terminal velocity of the raw material fine powder 403 in some cases. However, by setting the maximum cross-sectional area of the horizontal cross section in each of the freeboard portions 1102, 1102A, 1102B, 1102C, and 1102D to be larger than the cross-sectional area at which the superficial velocity of the gas in the freeboard portion becomes the terminal velocity of the raw material fine powder 403, the superficial velocity of the gas in the freeboard portion becomes slower than the terminal velocity of the raw material fine powder 403, so that jumping of the raw material fine powder 403 out of the granulation vessel 110 can be further suppressed.

The terminal velocity ut (m/s) of the raw material fine powder 403 can be represented by Formula (1) in a case where the particles of the raw material fine powder 403 are first-order approximated to a spherical shape.

$$ut = \sqrt{\frac{4 g ( {ρ}_{p} - {ρ}_{f} )}{3 {C}_{d} {ρ}_{p}} {D}_{p}} \qquad Formula ( 1 )$$

In Formula (1), g (m/s²) is a gravitational acceleration, ρₚ (kg/m³) is the particle density of the raw material fine powder 403, ρ_{f} (kg/m³) is the density of the supply gas, Dₚ (m) is a median diameter of the raw material fine powder 403, and Ca (−) is a drag coefficient organized by the Reynolds number Re and is represented below by using the approximation formula (Formula (2)) of Brown and Lawler.

$${C}_{d} = ( 24 ( 1 + 0.15 {Re}^{0.681} ) / Re ) + ( 0.407 / ( 1 + 8710 {Re}^{- 1} ) \qquad Formula ( 2 )$$

g=9.8 (m/s²), and a true density of iron ore particles that can constitute the raw material fine powder 403 depends on a content of a gangue component, but ρₚ=4,000 to 5,300 kg/m³) in many cases. In addition, when the gas density ρ_{f} of the supply gas is set to ρ_{f}=0.0899 to 1.784 (kg/m³) as a range of mixing conditions for candidate gas types, and Dₚ=50×10⁻⁶ (m) and Re=0.01 to 2 are set, the terminal velocity ut of the raw material fine powder 403 becomes 0.03 to 0.5 m/s from Formulas (1) and (2).

Although the details will be described later, a flow velocity U of the supply gas is equal to or faster than the minimum fluidization velocity of the fluidized bed and is, for example, 0.02 m/s or faster and 0.8 m/s or slower. For example, in a case of granulation into granular powder with the terminal velocity ut of the raw material fine powder 403 set to 0.5 m/s and the flow velocity U of the supply gas set to 0.8 m/s, by setting the maximum cross-sectional area of the horizontal cross section in the freeboard portion to more than 0.8/0.5 times (=1.6 times) a cross-sectional area of a fluidization portion, the superficial velocity of the gas in the freeboard portion becomes slower than the terminal velocity of the raw material fine powder 403, so that jumping of the raw material fine powder 403 out of the granulation vessel 110 can be further suppressed.

As the median diameter of the raw material fine powder 403 decreases, the terminal velocity ut of the raw material fine powder 403 decreases. Therefore, in order to suppress the jumping of the raw material fine powder 403 out of the granulation vessel 110, the smaller the median diameter of the raw material fine powder 403 becomes, the larger the maximum cross-sectional area of the horizontal cross section in the freeboard portion may be. However, from the viewpoint of facility design, it is preferable that the maximum cross-sectional area of the horizontal cross section in the freeboard portion is set to less than 3,000 times.

As described above, the cross-sectional area of the horizontal cross section in the freeboard portion may be determined by the flow velocity of the supply gas, the median diameter of the raw material fine powder 403, the density of the particles of the raw material fine powder 403, and the like.

Although the raw material fine powder 403 is fed from the raw material fine powder supply port 112, the raw material fine powder supply port 112 may be provided with a device for controlling feeding of the raw material fine powder 403 as appropriate. Examples of such a device include a slide gate and a spreader. The medium particles 401 may be fed from the raw material fine powder supply port 112.

The distributor 113 is a plate having a plurality of vent holes. The supply gas supplied to the inside of the granulation vessel 110 from the gas supply port 111 passes through the vent holes of the distributor 113 and is rectified.

The outlet 114 is an outlet for the gas inside the granulation vessel 110. Depending on the flow velocity of the supply gas, the raw material fine powder 403 may be discharged to the outside of the granulation vessel 110 from the outlet 114. Therefore, it is preferable that the dry dust collector 120, which will be described below, is connected to the outlet 114.

### [Dry Dust Collector 120]

There are cases where, in the granulation apparatus 10, the raw material fine powder 403 may be included in exhaust gas (off-gas) discharged from the outlet 114. Therefore, it is preferable to collect the raw material fine powder 403 included in the off-gas using the dry dust collector 120. The dry dust collector 120 is connected to the outlet 114 as shown in FIG. 1. The exhaust gas including the raw material fine powder 403 is sent to the dry dust collector 120 through the outlet 114, and the raw material fine powder 403 is collected by the dry dust collector 120. As the dry dust collector 120, for example, a cyclone, a multiclone, or a ceramic filter can be used. The raw material fine powder 403 collected by the dry dust collector 120 can be fed into the granulation vessel 110 again. For example, as shown in FIG. 1, the raw material fine powder 403 can be fed into the granulation vessel 110 by a configuration in which a pipe having a valve 121 is provided under the dry dust collector 120, and the dry dust collector 120 is connected through the pipe to the vessel 170 provided with a pipe having a valve 171. Specifically, the particulate fluidized bed 400 is formed in a state where the valves 121 and 171 are closed. By opening the valve 121 in this state, the raw material fine powder 403 is stored in the vessel 170. Thereafter, by closing the valve 121 and opening the valve 171, it is possible to discharge the raw material fine powder 403 accumulated in the vessel 170 without discharging the gas in operation to the outside. The discharged raw material fine powder 403 may be fed into the granulation vessel 110 from the raw material fine powder supply port 112 using various methods. For example, a pipe may be connected to the raw material fine powder supply port 112 to feed the raw material fine powder 403 into the granulation vessel 110 from the raw material fine powder supply port 112 by air flow transportation, or the raw material fine powder 403 may be fed into the granulation vessel 110 from the raw material fine powder supply port 112 by a manual operation. In addition, there are cases where powder collected by the dry dust collector 120 includes granular powder as well as the raw material fine powder 403.

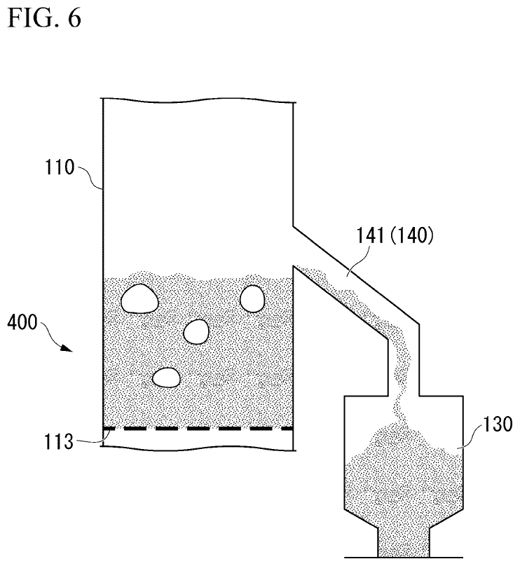

It is preferable that the granulation apparatus 10 includes a granular powder separation device 130 that separates the granular powder from the particulate fluidized bed 400, and a transporting device 140 that transports powder including the medium particles 401 or the raw material fine powder 403 or combination thereof to the granular powder separation device 130. Hereinafter, the granular powder separation device 130 and the transporting device 140 will be described with reference to FIGS. 6 to 8. The granular powder separation device 130 and the transporting device 140 shown in FIGS. 6 to 8 are merely examples and are not limited thereto.

### [Granular Powder Separation Device 130]

The granular powder separation device 130 includes a mechanism of magnetic separation, dry sieving, pneumatic classification, or sedimentation classification, or any combination thereof. The granular powder produced by the granulation apparatus 10 is separated and recovered from the medium particles 401 by the granular powder separation device 130.

In a case where the granular powder separation device 130 includes the dry sieving mechanism, the granular powder extracted together with the medium particles 401 is separated from the medium particles 401 using, for example, a particle size difference from the sufficiently large medium particles 401. At this time, the raw material fine powder 403 that has not been granulated to a predetermined particle size may be separated from the granular powder that has reached a predetermined particle size range by sieving and may be returned to the granulation vessel 110 again together with the medium particles 401. The dry sieving mechanism includes, for example, a first sieve inclined to one side, and a second sieve that is disposed at a position below the first sieve to be inclined to a side opposite to the inclination direction of the first sieve and has a smaller mesh size than that of the first sieve. The first sieve disposed in the upper portion captures the medium particles 401 which are coarse particles, but allows the granular powder and the raw material fine powder 403 which have a particle size smaller than that to be captured to be passed therethrough, and the second sieve which is disposed in the lower portion captures the granular powder, but allows the raw material fine powder 403 to be passed therethrough. Accordingly, the granular powder captured only by the second sieve disposed in the lower portion can fall into a transportation pipe on the reduction apparatus 20 side, so that it is possible to effectively separate the granular powder.

In addition, in a case where the granular powder separation device 130 included the magnetic separation mechanism, by using the fact that iron is generated in the granular powder granulated by a reaction using a reducing gas, a mechanism to allow the powder (mixed powder of the medium particles 401, the raw material fine powder 403, and the granular powder) extracted from the granulation apparatus 10 to fall is implemented, and by applying an external magnetic force to the granular powder to allow the granular powder in which iron is generated to fall into the transportation pipe on the reduction apparatus 20 side, the granular powder can be effectively separated. In addition, in a case of performing granulation by a reaction using an oxidizing gas, the raw material fine powder 403 is in a ferromagnetic magnetite state, but the granular powder after the granulation transitions from the magnetite state to a paramagnetic hematite state. Using this difference in magnetism between the raw material fine powder 403 and the granular powder, in the reverse order of the above, the raw material fine powder 403 and the granular powder are separated from each other by a magnetic force, and only the granular powder may be guided to the transportation pipe on the reduction apparatus 20 side.

Furthermore, in a case where the granular powder separation device 130 includes the pneumatic classification mechanism, by applying a constant wind from a horizontal direction while allowing the extracted powder (the mixed powder of the medium particles 401, the raw material fine powder 403, and the granular powder) to fall, only the granular powder can fall into the transportation pipe on the reduction apparatus 20 side using the fact that a displacement amount in the horizontal direction during falling varies depending on differences in particle size and specific gravity.

In a case where the granular powder separation device 130 includes the sedimentation classification mechanism, the extracted powder (the mixed powder of the medium particles 401, the raw material fine powder 403, and the granular powder) is fluidized with an inert gas in a separate vessel, and a flow velocity of the inert gas at this time is set to be equal to or faster than a minimum fluidization velocity of the raw material fine powder 403 and slower than a minimum fluidization velocity of the medium particles 401 to cause the medium particles 401 to settle in the fluidized bed, thereby enabling sequential discharge of the medium particles 401 from a lowermost portion and the granular powder from a middle portion, and achieving separation.

In order to efficiently separate the granular powder, a separation device having a mechanism in which two or more of the above methods are combined may be used.

### [Transporting Device 140]

The transporting device 140 is a device that transports the powder including the medium particles 401 or the raw material fine powder 403 or combination thereof to the granular powder separation device 130. The transporting device 140 may be a device having various powder discharge methods and transportation mechanisms.

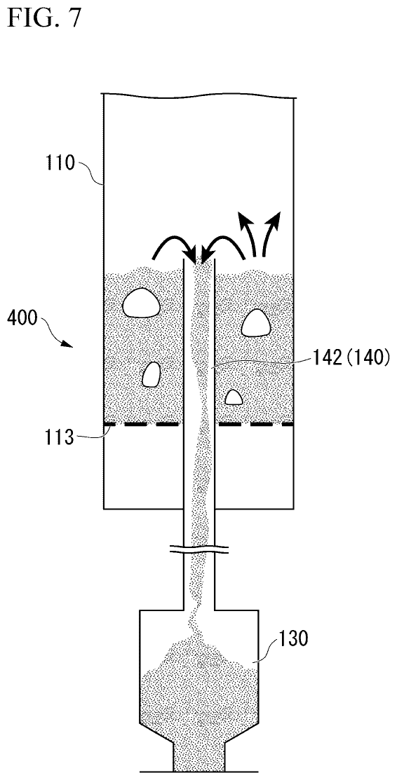

Examples of the powder discharge method include an overflow method in which powder blown up by a supply gas is discharged and a bottom portion extraction method in which powder is discharged from the bottom portion of the granulation vessel 110. Examples of the overflow method include a method in which, as shown in FIG. 6, the powder blown up by the supply gas is transported to the granular powder separation device 130 through an overflow pipe 141 connected to a wall surface of the granulation vessel 110, a method in which, as shown in FIGS. 7, the powder is transported to the granular powder separation device 130 through a downcomer 142 inserted from below the granulation vessel 110 to a vicinity of an upper surface of the particulate fluidized bed 400, and a combination of these methods.

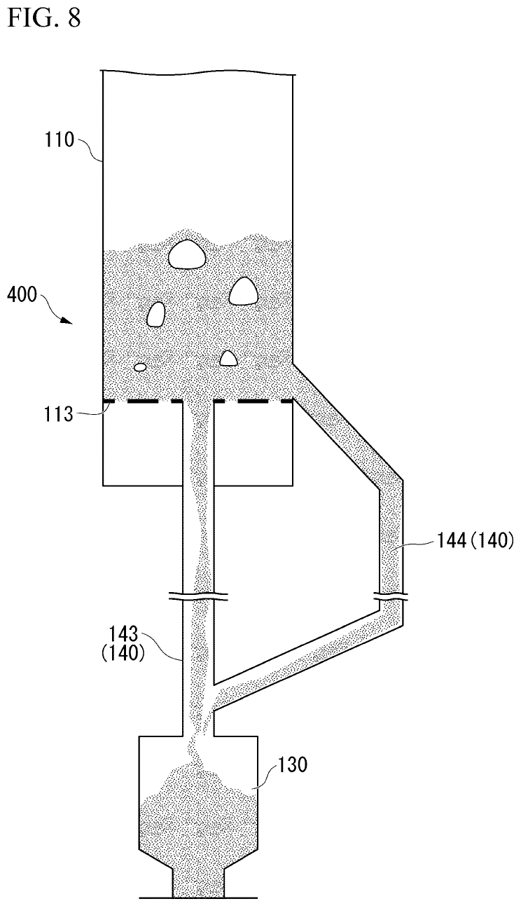

Examples of the bottom portion extraction method include a method in which, as shown in FIG. 8, the powder is transported to the granular powder separation device 130 through a downcomer 143 inserted from below the granulation vessel 110 to the distributor 113 or a downcomer 144 connected to the wall surface of the granulation vessel 110 near the distributor 113 or combination thereof.

The powder discharge method may be a combination of the overflow method and a jetting method.

In addition, as the transportation mechanism for transporting the discharged powder, various general-purpose powder supply and transportation mechanisms can be used. Examples of the powder supply and transportation mechanism include a rock hopper, a table feeder, a rotary valve, a screw feeder, and a pneumatic valve provided in the above-described overflow pipe 141 and the downcomers 142, 143, and 144. The powder may be supplied or transported by pneumatic transportation. The powder supply and transportation mechanism to be used preferably has excellent gas sealing properties, but is not limited thereto as long as the powder can be discharged and transported from the inside of the granulation vessel 110.

### [Pressure Measuring Device 150]

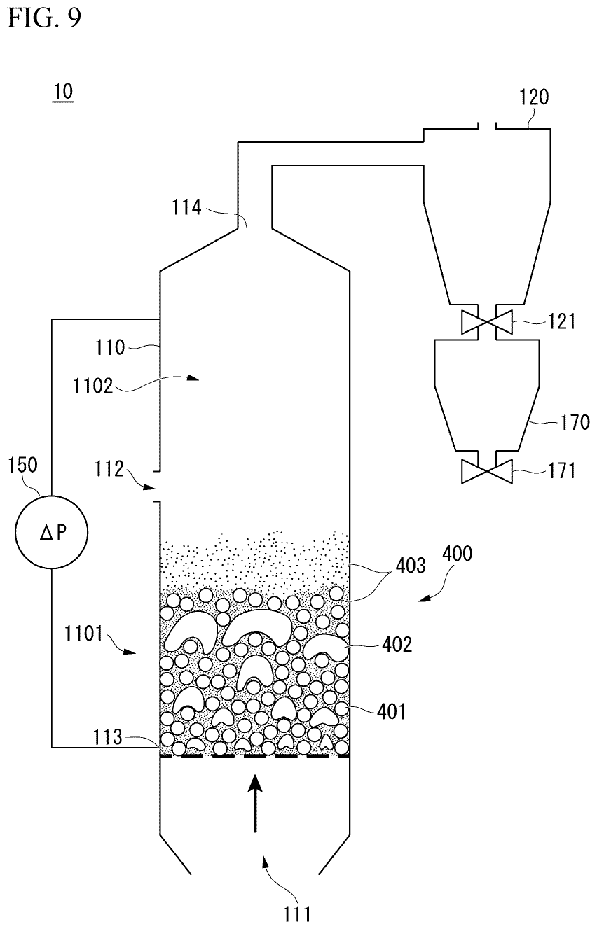

The granulation apparatus 10 according to the present embodiment preferably includes a pressure measuring device 150. The pressure measuring device 150 measures a pressure difference between a lower portion and a upper portion of a layer at which the medium particles 401 are present, and calculates a pressure loss of the particulate fluidized bed 400. The pressure measuring device 150 is constituted by, for example, a plurality of pressure gauges that measure pressures at positions having different heights. The pressure measurement position may be set so that the pressure loss of the particulate fluidized bed 400 can be measured. For example, as shown in FIG. 1, a pressure difference between a side below the distributor 113 and an uppermost portion of the freeboard portion 1102 may be measured. Alternatively, as shown in FIG. 9, a pressure difference between an area immediately above the distributor 113 and the uppermost portion of the freeboard portion 1102 may be measured. In a case where the cross-sectional area of the horizontal cross section differs depending on a position in the vertical direction as in the freeboard portions 1102A, 1102B, 1102C, and 1102D shown in FIGS. 2 to 5, it is preferable that a pressure at a position with the largest cross-sectional area is measured, and a pressure difference between the lower portion and the upper portion of the layer at which the medium particles 401 are present is measured to calculate the pressure loss of the particulate fluidized bed 400.

### [Particulate Fluidized Bed 400]

The particulate fluidized bed 400, which is a fluidized bed, is formed inside the granulation vessel 110 by causing the medium particles 401 to be fluidized by the gas that is supplied from the gas supply port 111 and is rectified through the plurality of vent holes of the distributor 113. Examples of a method and a form for ventilation of the gas for forming the particulate fluidized bed 400 include, in addition to the distributor 113 shown in FIG. 1 and a flat plate type such as a porous plate or a slit plate, a simple nozzle type, a cap type provided with a cap with various forms of blow holes at a nozzle tip, and a pipe type with grid tubes provided with a plurality of holes in a tube side surface, and specific forms thereof are not limited as long as the supply gas is supplied to the granulation vessel 110 to allow the particles to be blown up and form a fluidized bed.

The raw material fine powder 403 is supplied from the raw material fine powder supply port 112 into the granulation vessel 110 in which the particulate fluidized bed 400 is formed. In the particulate fluidized bed 400, the medium particles 401 having a larger particle size than the raw material fine powder 403, bubbles 402 of the supply gas (fluidizing gas), and the raw material fine powder 403 are present. With this particulate fluidized bed 400, larger granular powder is obtained from the raw material fine powder 403. The bubbles 402 have various morphologies depending on a fluidized state, and there are cases where clear bubbles are not formed depending on the fluidized state.

### [Raw Material Fine Powder 403]

The raw material fine powder 403 is a fine powder that contains iron and needs to be reduced and is, for example, a fine powder ore that has undergone beneficiation, a sieved fine particle size ore, dust that is discharged and recovered from various ironmaking processes, or dust that is collected by a collecting device (dry dust collectors 240 and 320) included in the reduction apparatus 20 described later. In addition, the raw material fine powder 403 may include a plurality of these. Specific examples of the fine powder ore that has undergone beneficiation include, in addition to pellet feed used as a raw material for pellets in the related art, magnetite concentrate and sinter feed and the like. The dust mentioned here includes so-called converter dust generated in a converter, fine particles of partially unreduced ore that can be generated in the reduction apparatus 20, fine particles of reduced iron, and the like. As a component range of the iron ore used for producing iron, the raw material fine powder 403 generally contains 50 to 70 mass % of Fe. From the viewpoint of reducing energy in a step of separating impurity components and suppressing an ore basic unit, for example, as the raw material fine powder 403, a raw material fine powder containing 55 to 68 mass % of Fe may be used.

The above-mentioned fine powder constituting the raw material fine powder 403 has a high density and exhibits a hardly fluidizable property when the median diameter is 50 μm or less. Therefore, the median diameter of the raw material fine powder 403 is 50 μm or less. The raw material fine powder 403 having a median diameter of more than 50 μm can be directly supplied to the reduction apparatus 20 to produce reduced iron without being subjected to granulation using the granulation apparatus 10. In addition, when the median diameter is more than 50 μm, the granular powder tends to become excessively large due to agglomeration and causes stop of the fluidization, so that it becomes difficult to perform granulation into a desired particle size while achieving stable fluidization in the granulation vessel 110. Therefore, the median diameter of the raw material fine powder 403 is 50 μm or less. Furthermore, when the median diameter of the raw material fine powder 403 is too large, a difference between the particle size of the granular powder into which the raw material fine powder 403 is granulated and the particle size of the medium particles 401 becomes small. In a case where this difference in particle size is small, when the granular powder and the medium particles 401 are separated from each other using the difference in particle size, there are cases where the separation becomes difficult. The median diameter of the raw material fine powder 403 is preferably 30 μm or less from the viewpoint of easily separating the medium particles 401 and the raw material fine powder 403 from each other.

On the other hand, a powder having a median diameter of less than 1 μm is difficult to recover and handle, and is therefore difficult to use as a raw material. Therefore, the median diameter of the raw material fine powder 403 is preferably 1 μm or more. However, the median diameter of the raw material fine powder 403 is not limited to this range, and even a powder of less than 1 μm or a powder of more than 50 μm can be used as the raw material fine powder 403 in a case where adjustment of conditions for agglomeration control and an operation for separation from the medium particles 401 are appropriately performed.

In addition, a high density of the raw material fine powder 403 means that the true density thereof is 500 kg/m³ or more.

The median diameter of the raw material fine powder 403 can be measured by the following method. That is, a volume-based particle size d₅₀ in an undersize cumulative distribution measured using a laser diffraction type particle size measuring device (Mastersizer 3000 manufactured by Malvern Panalytical Ltd), which is a wet type measuring device, is defined as the median diameter d₅₀ of the raw material fine powder 403. Setting conditions during the measurement include dispersion medium: water, dispersion medium refractive index: 1.33, and particle refractive index: 2.918 (refractive index of iron oxide Fe₂O₃). In a case of a raw material fine powder including particles having a large particle size, the raw material fine powder is sieved through a dry sieve, a particle size of a powder randomly sampled from the undersize raw material fine powder is measured by the laser diffraction type particle size measuring device three times, and a dso average value thereof is taken as the median diameter.

### [Medium Particle 401]

The medium particles 401 are indispensable for the formation of the fluidized bed for turning the raw material fine powder 403 into the granular powder, and need to maintain shapes thereof during the fluidization without undergoing thermal decomposition during the fluidization. Therefore, the medium particles 401 are particles that do not thermally decompose during fluidization. The medium particles 401 are preferably particles containing a carbide, an oxide, or a nitride, or any combination thereof, particularly, ceramics particles. In the granulation process, there are cases where a reducing gas is used as the supply gas (fluidizing gas), and the raw material fine powder 403 is granulated while being reduced, and cases where an oxidizing gas is used and the raw material fine powder 403 is granulated while being oxidized. Therefore, since a temperature range for the oxidation reaction of the raw material fine powder 403 is about 1,200° C. or lower and a temperature range for the reduction reaction is about 900° C. or lower, the medium particle 401 is preferably a high-melting-point material that has a melting point of higher than 1,200° C. and does not undergo melting thermal decomposition at least up to a temperature of 1,200° C. Furthermore, in a case where a reducing gas is used, the medium particle 401 is more preferably a material that is inert even in a reducing atmosphere such as hydrogen or CO gas, and more preferably, for example, a carbide or a nitride. Examples of the carbide include SiC, TiC, TaC, and WC. Examples of the nitride include Si₃N₄ and BN. In a case where an oxidizing gas is used, the medium particle 401 is more preferably a material that is inert in an O₂ gas atmosphere, and more preferably, for example, an oxide. Examples of the oxide include SiO₂, Al₂O₃, ZrO₂, and MgO. It should be noted that substances that can undergo a decomposition reaction in the oxidizing or reducing atmosphere as described above are not suitable as the medium particles. For example, particles made of coal are not suitable as medium particles.

A median diameter of the medium particles 401 is preferably 0.2 mm or more and 0.8 mm or less. When the median diameter of the medium particles 401 is 0.2 mm or more and 0.8 mm or less, the medium particles 401 are uniformly fluidized by the supply of the gas, and the particulate fluidized bed 400 is likely to be formed. The median diameter of the medium particles 401 is more preferably 0.3 mm or more. The median diameter of the medium particles 401 is more preferably 0.6 mm or less. The median diameter of the medium particle 401 is even more preferably 5 times or more, and still more preferably 10 times or more the median diameter of the raw material fine powder 403 in the above range. When the median diameter of the medium particles 401 is 0.3 mm or more and 0.6 mm or less and is 10 times or more the median diameter of the raw material fine powder 403, an effect of an adhesion force to the medium particles 401 in close proximity becomes more dominant than a self-weight of the raw material fine powder 403 itself having a small particle size. Therefore, the raw material fine powder 403 adheres to the medium particles 401 and clings around the medium particles 401, so that the raw material fine powder 403 is also easily fluidized together with the medium particles 401, facilitating the formation of the particulate fluidized bed 400.

The median diameter of the medium particles 401 can be measured by the same method as the method for measuring the median diameter of the raw material fine powder 403, and in this case, the particle refractive index is set depending on the material of the medium particles used.

Regarding a volume ratio between the medium particles 401 and the raw material fine powder 403 (hereinafter, the respective ratios to the total volume of the medium particles 401 and the raw material fine powder 403 may be simply referred to as volume ratios), for example, the volume ratio of the raw material fine powder 403 is 1 volume % or more and 30 volume % or less. The volume ratio of the raw material fine powder 403 is preferably 3 volume % or more. When the volume ratio of the raw material fine powder 403 is 3 volume % or more, a granulation processing efficiency of the raw material fine powder is improved. In addition, when the volume ratio of the raw material fine powder 403 is 30 volume % or less, the amount of the medium particles 401 present in the vicinity of the raw material fine powder 403 increases, and the amount of the raw material fine powder 403 adhered to the medium particles 401 increases. Therefore, blowing away of the raw material fine powder 403 alone by the fluidizing gas is suppressed. In addition, when the volume ratio of the raw material fine powder 403 is 30 volume % or less, a frequency of contact between the particles of the raw material fine powder 403 decreases, so that difficulties in fluidization and excessive progression of agglomeration are suppressed. The volume ratio of the raw material fine powder 403 is preferably less than 20 volume %.

The ratio of the raw material fine powder 403 and the ratio of the medium particles 401 to the total volume of the medium particles 401 and the raw material fine powder 403 can be measured by the following methods. That is, bulk densities of the medium particles 401 and the raw material fine powder 403 in a dried state are measured in advance, and weights with which predetermined volume ratios are achieved are obtained from the bulk densities. The volume ratio of the medium particles 401 and the volume ratio of the raw material fine powder 403 used can be calculated based on the weights corresponding to the measured bulk densities. The bulk density is measured using POWDER TESTER PT-X (manufactured by HOSOKAWA MICRON B.V.), and the bulk density is measured in a loose bulk density measurement mode.

### [Supply Gas]

The supply gas is not particularly limited, and an oxidizing gas, a reducing gas, or an inert gas can be used. However, the gas supplied to the granulation vessel 110 is preferably an oxidizing gas or a reducing gas.

The oxidizing gas is, for example, a gas containing oxygen, or may be air. By using the oxidizing gas, the raw material fine powder 403 in the granulation vessel 110 is oxidatively sintered, and can be easily granulated.

Examples of the reducing gas include hydrogen gas, a mixed gas of hydrogen and nitrogen, a mixed gas of hydrogen and Ar, a CO gas, and a synthetic gas (a mixed gas of carbon monoxide and hydrogen). The reducing gas may be a mixed gas of hydrogen and water vapor or a mixed gas of hydrogen, water vapor, and nitrogen. By using the reducing gas, surfaces of the particles of the raw material fine powder 403 in the granulation vessel 110 are reduced, and the particles of the raw material fine powder 403 are likely to adhere to each other. Therefore, granulation can be facilitated. The reducing gas is more preferably hydrogen gas. Hydrogen gas has a faster reduction rate than CO gas and does not generate carbon dioxide that is generated in a case where the CO gas or a synthetic gas is used. Therefore, the hydrogen gas has a small environmental burden.

The flow velocity of the supply gas is equal to or faster than the minimum fluidization velocity of the fluidized bed, and is, for example, 0.02 m/s or faster and 0.8 m/s or slower. The flow velocity of the supply gas is preferably 0.03 m/s or faster. In addition, the flow velocity of the supply gas is preferably 0.6 m/s or slower. From the viewpoint of stably fluidizing the medium particles 401 having a large particle size, the flow velocity of the supply gas is preferably about 1.2 times or more and about 3 times or less the minimum fluidization velocity of the medium particles 401. The minimum fluidization velocity is a minimum gas flow velocity at which the pressure loss in the fluidized bed is constant with respect to an increase in the gas flow velocity, and can be experimentally measured by the following method. That is, for example, as shown in FIG. 1, the pressure difference between the lower portion and the upper portion of the layer at which the medium particles 401 are present (a difference in pressure between a gas reservoir portion under the distributor 113 and a space part (the freeboard portion 1102) of the upper portion of the layer) is measured by the pressure measuring device 150, and the pressure loss of the particulate fluidized bed 400 is obtained by subtracting a differential pressure (pressure loss in the distributor only) in a case where the medium particles 401 and the raw material fine powder 403 are not charged. This pressure loss of the particulate fluidized bed 400 is plotted against a gas superficial velocity, and the minimum gas flow velocity at which the pressure loss becomes constant is obtained. However, in order to eliminate dependence on an initial particle packing structure and acquire reproducible data, the minimum fluidization velocity is determined as a point at which the pressure loss begins to decrease from a constant region by gradually decreasing the gas flow velocity from a magnitude sufficient for fluidization. In the measurement of the pressure loss, the pressure measurement position does not need to be limited to the gas reservoir portion under the distributor 113 and the freeboard portion 1102. As shown in FIG. 9, the pressure measurement position may be, for example, the area immediately above the distributor 113 and an uppermost portion of the region 1101 in which the particulate fluidized bed 400 below the freeboard portion 1102 is disposed, and may be a pressure measurement position at which the pressure loss of the particulate fluidized bed 400 can be measured.

Depending on the cross-sectional area of the horizontal cross section in the freeboard portion, there are cases where the superficial velocity of the gas in the freeboard portion becomes faster than the terminal velocity of the raw material fine powder 403. Therefore, the flow velocity of the supply gas is preferably determined according to the maximum cross-sectional area of the horizontal cross section in the freeboard portion.

In addition, from the viewpoint of realizing a stable operation, the granulation apparatus 10 may be configured to monitor the pressure loss in the particulate fluidized bed 400 in the granulation vessel 110 at any time. In a case where agglomeration progresses excessively or in a case where a gas bypass phenomenon (channeling) occurs in a region where the raw material fine powder 403 is segregated, abnormalities occur, such as the pressure loss becoming excessively large by a weight of the particulate fluidized bed 400 or more due to clogging of the entire particulate fluidized bed 400, or the pressure loss approaching zero due to a state in which the gas blows through the particulate fluidized bed 400 and does not contribute to the fluidization. In this case, large-scale maintenance may be required for the granulation apparatus 10. However, in a case where the pressure loss in the particulate fluidized bed 400 is monitored at any time, it becomes possible to stop the facility at an appropriate time before the maintenance load increases due to the progress of clogging or segregation. Such a configuration is realized by the pressure measuring device 150.

The flow velocity of the supply gas is a value obtained by dividing a gas flow rate supplied per unit time to the granulation vessel 110 by the cross-sectional area of the vessel, and the gas flow rate can be measured with a flow meter attached to a gas supply pipe.

A temperature of the particulate fluidized bed 400 in the granulation vessel 110 is not particularly limited, but is preferably 800° C. or higher and 1,200° C. or lower in a case where the supply gas is an oxidizing gas and 500° C. or higher and 900° C. or lower in a case where the supply gas is a reducing gas. When the temperature in the particulate fluidized bed 400 is in these ranges, the oxidation reaction or the reduction reaction of the raw material fine powder 403 is promoted, and it is possible to efficiently perform granulation. A method of controlling the temperature in the particulate fluidized bed 400 is not particularly limited. However, temperature control of the particulate fluidized bed 400 is easier compared to other reaction control methods because the particulate fluidized bed 400 features extremely good mixing of a gas and substances and thus features homogenization of the temperature in the particulate fluidized bed 400. As a heating method, a reaction temperature in the particulate fluidized bed 400 can be adjusted by enclosing the granulation vessel 110 with a heat insulating material and supplying and mixing the particles and gas preheated to a predetermined temperature. In addition, it is also possible to adjust the temperature inside the particulate fluidized bed 400 to a predetermined temperature by heating the granulation vessel 110 from the outside to exchange heat with the wall surface of the vessel.

A temperature of the supply gas is a temperature measured at a position of the lower portion (a lower portion of the distributor 113) of the layer charged with the medium particles 401.

A mean residence time of the raw material fine powder 403 in the granulation vessel 110 may be determined in consideration of a desired particle size of the granular powder and productivity, and, under high temperature conditions, granulation into the desired particle size can be achieved within a shorter period of time. The mean residence time of the raw material fine powder 403 in the granulation vessel 110 is, for example, 3 minutes or longer and 60 minutes or shorter. The mean residence time is preferably 30 minutes or shorter from the viewpoint of the granulation efficiency and from the viewpoint of avoiding excessive agglomeration of the granular powder. The mean residence time can be controlled by changing a supply gas rate, a height of the particulate fluidized bed 400, an extraction rate of the particles from the granulation vessel 110, and the like.

### [Granular Powder]

The granular powder is powder obtained by granulating the raw material fine powder 403. Since the granular powder is larger in size than the raw material fine powder 403, the granular powder exhibits a favorable fluidizable property compared to the raw material fine powder 403. In order to perform a stable operation, a median diameter of the granular powder is preferably 0.02 mm or more. The median diameter of the granular powder is more preferably more than 0.05 mm. When the median diameter of the granular powder is more than 0.05 mm, the granular powder exhibits a more excellent fluidizable property, and the granular powder can be more stably reduced by a circulating fluidized bed or a bubbling fluidized bed in the reduction apparatus 20. Therefore, the median diameter of the granular powder is preferably more than 0.05 mm. On the other hand, the median diameter of the granular powder is preferably less than 0.10 mm. The median diameter of the granular powder is more preferably 0.08 mm or less. This is because when the median diameter of the granular powder becomes too large due to agglomeration, there is a concern that stable fluidization in the granulation vessel 110 is hindered, and depending on cases, there is a possibility of partial blockage in the granulation vessel 110, such as in the vent holes of the distributor 113. In addition, when the granular powder is as large as the particle size of the medium particles 401, in a case where the medium particles 401 and the granular powder are separated from each other by a particle size difference, the separation becomes difficult. Therefore, the median diameter of the granular powder is more preferably 0.08 mm or less.

The median diameter of the granular powder can be adjusted by changing components of the medium particles 401, the median diameter of the medium particles 401, the volume ratio of the raw material fine powder 403 to the volume of the medium particles 401, the type of the supply gas, the velocity of the supply gas, the temperature, or the residence time and the like as described above. In the adjustment, the easiest adjustment method is to fine the extraction rate at which granulation into a desired particle size is achieved by changing the mean residence time in the granulation vessel 110 by changing the extraction rate (the amount of the particles discharged per unit time or at regular time intervals) of the particles in the granulation vessel 110 under constant temperature and gas flow velocity conditions.

The median diameter of the granular powder can be measured by the same method as the method for measuring the median diameter of the raw material fine powder 403.

In a case where the supply gas is a reducing gas, a reduction degree of the granular powder is preferably 33% or more and 80% or less, and more preferably 40% or more and 70% or less. The reduction degree can be calculated by the following method. That is, about 0.1 g of the granular powder is weighed into a quartz cell in a glove box with a nitrogen atmosphere, and the granular powder is immersed in benzene in order to prevent the granular powder from coming into contact with air. The quartz cell is installed in a thermobalance (manufactured by SHINKU-RIKO Inc., TGD7000), and the system is evacuated. Thereafter, nitrogen is flowed at 2.00×10⁻⁴ m³/min and the temperature is raised to 200° C. at a temperature rising rate of 20° C./min to evaporate the benzene. Then, the temperature is raised to 700° C. at a temperature rising rate of 20° C./min, and after the temperature and the balance are stabilized, oxygen is introduced into the system and is held until there is no further increase in weight. Next, the inside of the system is cooled to 100° C. or lower, evaluated, and purged with nitrogen, and the temperature is raised again to 700° C. at a temperature rising rate of 20° C./min. Then, the hydrogen gas is flowed at 2.00×10⁻⁴ m³/min and is held until a change in weight is not recognized. The reduction degree is obtained from Formula (3) based on the above-described change in weight.

$$X = \{ ( {m}_{Fe 2 O 3} - {m}_{sample} ) - 0.329 \times ( {m}_{Fe 2 O 3} - {m}_{Fe} ) \} / \{ 0.671 \times ( ( {m}_{Fe 2 O 3} - {m}_{Fe} ) \} \qquad Formula ( 3 )$$

Here, in the formula, X is the reduction degree (%), m_{Fe2O3} is the weight of the granular powder after oxidation (the weight of the granular powder when there is no further increase in weight after the introduction of oxygen), mₛₐₘₚₗₑ is the weight of the granular powder, and m_{Fe} is the weight of the granular powder after the reduction (the weight of the granular powder when there is no further increase in weight after the introduction of hydrogen gas). Chemical forms of the granular powder after oxidation and after reduction by the thermobalance can be verified as Fe₂O₃ and Fe, respectively, by X-ray diffraction.

When the reduction degree is 33% or more, metallic iron appears on the surfaces of the particles of the raw material fine powder 403. This allows the progress of granulation using adhesion by contact with the metallic iron. When the reduction degree is small, granulation by adhesion does not progress. On the other hand, when the reduction degree exceeds 80% and becomes too large, adhesion between particles of the metallic iron tends to progress excessively, leading to difficulties in controlling the particle size through granulation. Although granulation depends on the form of the raw material fine powder 403 and the gangue component content and thus cannot be unconditionally specified, it is more preferable to set the conditions so that the reduction degree is in a range of 40% or more and 70% or less.

Hitherto, the granulation apparatus 10 has been described. The granulation apparatus 10 may be a batch type processing apparatus or a continuous type processing apparatus. In a case of the batch type, the granular powder after the granulation process is extracted together with the medium particles 401, for example, from the transporting device 140 connected to an openable extraction port provided in the lower portion of the granulation vessel 110. In a case of the continuous type, for example, a valve of an openable extraction port provided in the granulation vessel 110 is opened at regular time intervals or continuously, and the granular powder is extracted to the transporting device 140 together with the medium particles 401, while the medium particles 401 are supplied from the upper portion of the granulation vessel 110.

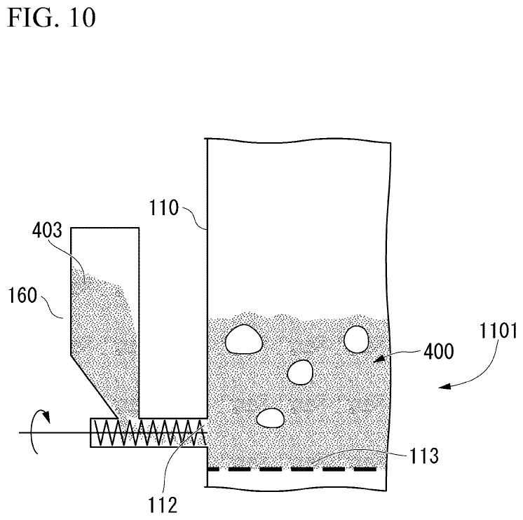

In addition, in the above-described granulation apparatuses 10, 10A, 10B, 10C, and 10D, the raw material fine powder 403 is fed into a surface of the particulate fluidized bed 400 from the raw material fine powder supply port 2. However, the feeding of the raw material fine powder 403 is not limited to the above aspect, and various aspects may be adopted. For example, as shown in FIG. 10, the raw material fine powder supply port 112 is provided in the region 1101 in which the particulate fluidized bed 400 is formed, and a screw feeder 160 connected to the raw material fine powder supply port 112 may supply the raw material fine powder 403.

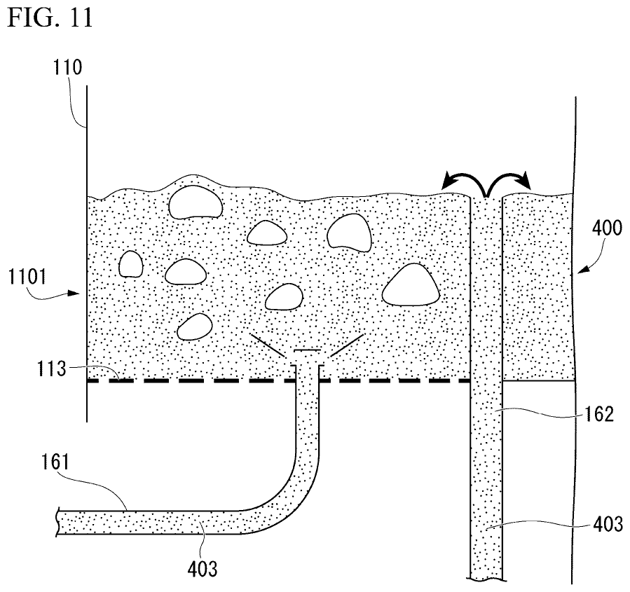

In addition, as shown in FIG. 11, the raw material fine powder 403 may be pneumatically transported into the granulation vessel 110 through a first supply pipe 161 that is connected to the distributor 113 of the granulation vessel 110 and a second supply pipe 162 that is inserted from below the granulation vessel 110 and extends to a vicinity of the surface of the particulate fluidized bed 400. Only either the first supply pipe 161 or the second supply pipe 162 can be provided, and the raw material fine powder 403 may be pneumatically transported into the granulation vessel 110 through the first supply pipe 161 or the second supply pipe 162.

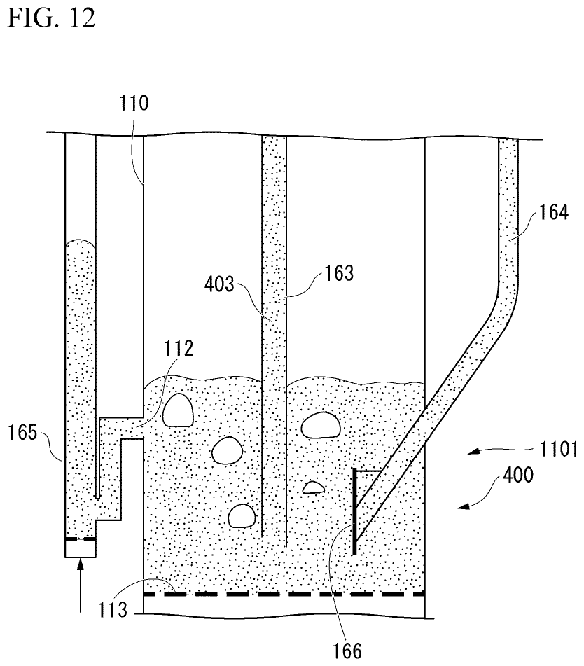

In addition, as shown in FIG. 12, the raw material fine powder 403 may be supplied to the inside of the granulation vessel 110 by the self-weight of the raw material fine powder 403 through a lance 163 immersed in the particulate fluidized bed 400 from above, a downcomer 164 inserted into the particulate fluidized bed 400 from a side surface of the granulation vessel 110, or a supply pipe 165 connected to the raw material fine powder supply port 112 provided in the region 1101, or combination thereof. A orifice (not shown) may be provided at a tip end of the lance 163. In addition, the downcomer 164 may be provided with a valve for controlling the supply of the raw material fine powder 403, for example, a trickle valve 166. In addition, it is preferable that an auxiliary air flow is introduced into the supply pipe 165.

Various aspects may also be adopted for the feeding of the raw material fine powder 403 recovered by the dry dust collector 120.

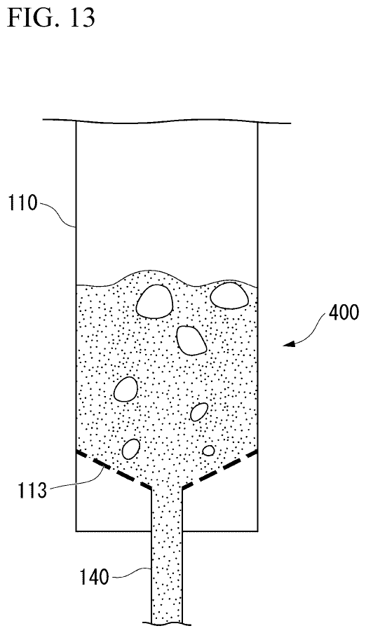

In addition, as shown in FIG. 13, the distributor 113 may be inclined toward the transporting device 140 in order to facilitate the transfer of the medium particles 401 and the granular powder to the transporting device 140 connected to a side below the granulation vessel 110.

### <Reduction Apparatus 20>

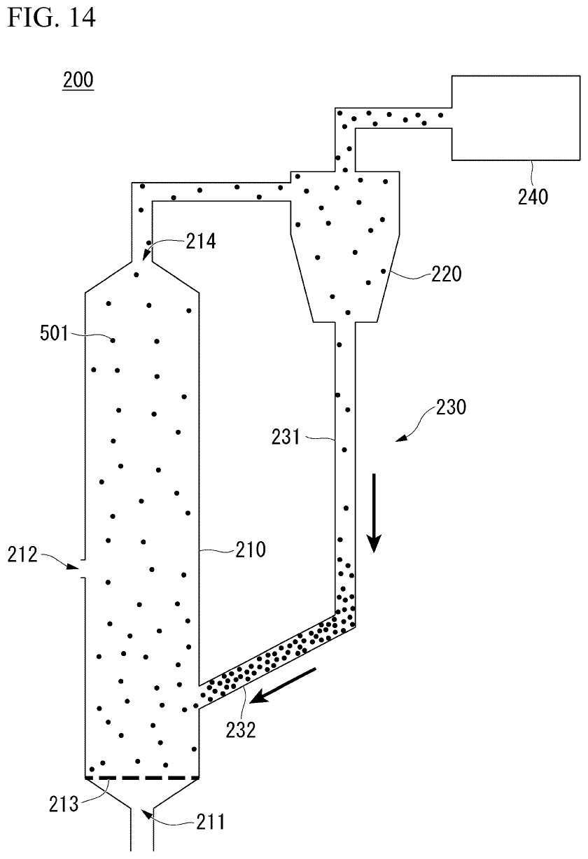

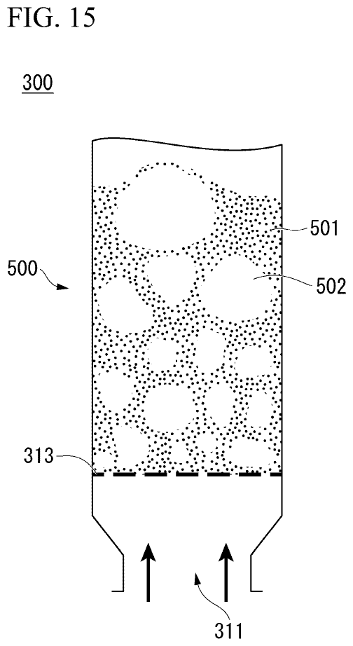

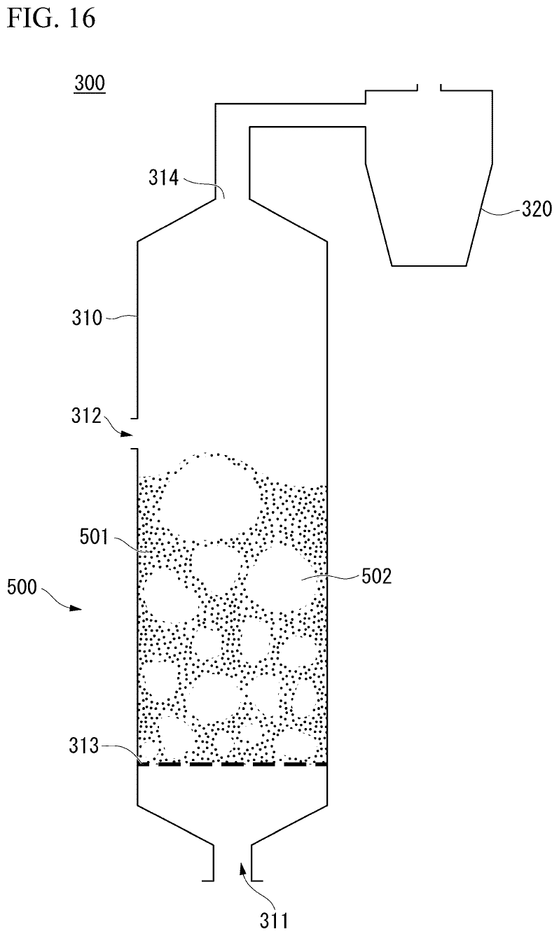

Subsequently, the reduction apparatus 20 will be described with reference to FIGS. 14 to 16. FIG. 14 is a schematic diagram of a circulating fluidized bed reduction apparatus 200 in which the reduction apparatus 20 in the present embodiment can be configured. FIG. 15 is a schematic diagram for describing the bubbling fluidized bed. FIG. 16 is a schematic diagram of a bubbling fluidized bed reduction apparatus 300 in which the reduction apparatus 20 in the present embodiment can be configured.

The reduction apparatus 20 reduces at least ore powder 501 in a fluidized bed formed by fluidizing the ore powder 501 including at least the granular powder granulated in the granulation apparatus 10. The reduction apparatus 20 includes, for example, one or more circulating fluidized bed reduction apparatuses 200 in which a circulating fluidized bed is formed or one or more bubbling fluidized bed reduction apparatuses 300 in which a bubbling fluidized bed (BFB) is formed or combination thereof. Hereinafter, the circulating fluidized bed reduction apparatus 200 and the bubbling fluidized bed reduction apparatus 300 will be described.

### (Circulating Fluidized Bed Reduction Apparatus 200)

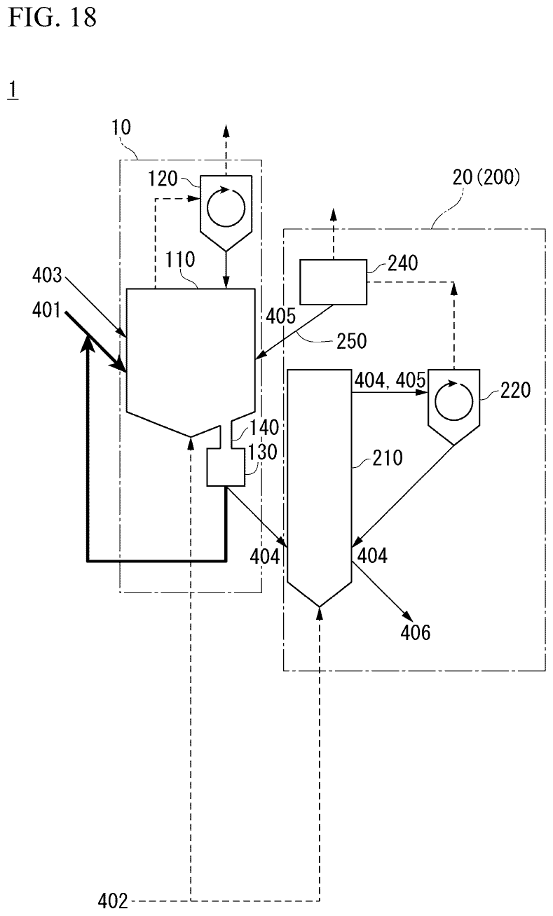

The circulating fluidized bed reduction apparatus 200 includes, for example, as shown in FIG. 14, a riser portion 210 which is a vessel in which the ore powder 501 is reduced, a cyclone 220 connected to an outlet 214 provided in an upper portion of the riser portion 210, and a circulation line 230 extending downward from a bottom portion of the cyclone 220 and connected to a lower portion of the riser portion 210. It is preferable that the circulating fluidized bed reduction apparatus 200 includes, as necessary, the dry dust collector 240 that is connected to the cyclone 220 and recovers pulverized ore having a low reduction degree or reduced iron (dust) contained in the off-gas, and a feeding device 250 (see FIG. 18) that feeds the dust into the granulation vessel 110 of the granulation apparatus 10.

### [Riser Portion 210]

The riser portion 210 includes a gas supply port 211 that is disposed at a bottom portion of the riser portion 210 to supply a supply gas to an inside of the riser portion 210, an ore powder supply port 212 through which the ore powder 501 is supplied, and a distributor 213 that is disposed above the gas supply port 211.

The ore powder 501 supplied from the ore powder supply port 212 includes at least the granular powder granulated by the granulation apparatus 10. The ore powder 501 is not limited to the granular powder granulated by the granulation apparatus 10 and may include, for example, fine powder ore having a particle size exhibiting a fluidizable property.

Examples of the supply gas supplied from the gas supply port 211 to the inside of the riser portion 210 may include a reducing gas such as hydrogen gas, CO gas, and a synthetic gas (a mixed gas of carbon monoxide and hydrogen) and a mixed gas of a reducing gas and an inert gas. The gas supplied to the inside of the riser portion 210 may be a combination of a reducing gas, an inert gas, and water vapor. The ore is reduced by the above supply gas, whereby reduced iron is obtained. The reducing gas is more preferably hydrogen gas. In the production of reduced iron using a shaft furnace in the related art, natural gas, coal, or CO gas is used in a reduction reaction, leading to the generation of CO₂, which can contribute to global warming, resulting in a significant environmental burden. On the other hand, in a case where hydrogen gas is used as the reducing gas to be supplied to the riser portion 210, CO₂ is not generated due to a reduction reaction, and a burden on the environment can be suppressed.

A flow velocity of the supply gas depends on the particle size of the ore powder 501, but is, for example, 1.0 m/s or faster and 10 m/s or slower. The flow velocity of the supply gas (gas superficial velocity) is preferably set so that a difference (slip velocity) between an average gas velocity and an average velocity of the particles becomes larger from the viewpoint of improving a reaction efficiency with the gas, which is an advantage of the circulating fluidized bed. The flow velocity of the supply gas is preferably 3.0 m/s or faster and 7.0 m/s or slower from the viewpoint of a specific gravity of ordinary iron ore and a particle size range of the granular powder.

The flow velocity of the supply gas is a superficial velocity at a position of the riser portion 210 at which the ore powder 501 is blown up, is a value obtained by dividing a gas flow rate supplied per unit time by a cross-sectional area of the riser portion 210 of the vessel, and can be measured with a flow meter attached to a gas supply pipe.

A reduction reaction temperature in the reduction apparatus 20 is preferably 500° C. or higher and 900° C. or lower. When the reduction reaction temperature in the reduction apparatus 20 is 500° C. or higher and 900° C. or lower, the reduction reaction of the ore powder 501 is promoted, and manufacturability is improved. The reduction reaction temperature in the reduction apparatus 20 is more preferably 550° C. or higher from the viewpoint of improving a reduction rate of the ore powder 501 and efficiently obtaining reduced iron. In addition, the reduction reaction temperature in the reduction apparatus 20 is more preferably 850° C. or lower from the viewpoint of suppressing the excessive progress of agglomeration due to adhesion between particles of the ore powder 501.

### [Cyclone 220]

The cyclone 220 collects particles scattered together with exhaust gas. The collected particles are returned to the riser portion 210 through the circulation line 230, and the exhaust gas is discharged to the outside of the circulating fluidized bed reduction apparatus 200 via the dry dust collector 240.

### [Circulation Line 230]

The circulation line 230 includes a downcomer 231, which is connected to a lower portion of the cyclone 220 and is a flow path of the ore powder 501 separated from the gas by the cyclone 220, and a loop seal portion 232 having one end connected to a lower end of the downcomer 231 and the other end connected to a side above the distributor 213 of the riser portion 210. The loop seal portion 232 functions as a seal due to the temporary accumulation of the ore powder 501. As in the case of the fluidized bed in the granulation vessel 110 of the granulation apparatus 10, examples of a method and a form for ventilation of the gas for forming the circulating fluidized bed include, in addition to a flat plate type such as a porous plate or a slit plate for the distributor 213, a simple nozzle type, a cap type provided with a cap with various forms of blow holes at a nozzle tip, and a pipe type with grid tubes provided with a plurality of holes in a tube side surface, and specific forms thereof are not limited as long as the supply gas is supplied to the riser portion 210 to allow the particles to be blown up and form a fluidized bed.

### [Dry Dust Collector 240]

In the circulating fluidized bed reduction apparatus 200, there are cases where the exhaust gas (off-gas) contains pulverized ore having a low reduction degree or reduced iron (dust). Therefore, it is preferable to collect the pulverized ore having a low reduction degree or the reduced iron contained in the off-gas using the dry dust collector 240. The ore or reduced iron collected by the dry dust collector 240 can be used as the raw material fine powder 403 to be supplied to the granulation apparatus 10. Accordingly, it is possible to realize a reduction system in which a dust loss is reduced and a yield of a weight of product reduced iron with respect to a total weight of the injected raw material is improved. That is, in the granulation apparatus 10 provided in a front stage of the reduction apparatus 20, as the raw material fine powder 403, for example, fine powder ore such as pellet feed having a small particle size, ore of fine particles sieved from powder ore such as sinter feed having a wide particle size distribution, converter dust including a significant amount of wüstite due to partial progress of reduction, and reoxidizable fine powder such as magnetite concentrate are granulated. The granular powder, which has been granulated into a particle size that is easily fluidized, is transported to the reduction apparatus 20 and subjected to a reduction process for a sufficient residence time, but dust is newly generated in the reduction apparatus 20. The dust is recovered from the off-gas and is returned to the granulation apparatus 10 again, whereby it becomes possible to efficiently perform the reduction process using the raw material fine powder 403 as a starting material at a high yield. The dry dust collector 240 corresponds to the collecting device according to the present invention.

As the dry dust collector 240, for example, a cyclone, a multiclone, or a ceramic filter or the like can be used. In the circulating fluidized bed reduction apparatus 200, for example, a cyclone smaller than the cyclone 220 may be provided in series as the dry dust collector 240 behind the cyclone 220.

### [Feeding Device 250]

The feeding device 250 transports the fine powder collected by the dry dust collector 240 from the dry dust collector 240 to the granulation vessel 110 of the granulation apparatus 10. That is, the feeding device 250 feeds the dust collected by the collecting device into the granulation vessel 110 of the granulation apparatus 10. Similarly to the transporting device 140, the feeding device 250 may be a device having various powder discharge methods and transportation mechanisms. However, in the circulating fluidized bed reduction apparatus 200, an extraction port (not shown) may be provided in the lower portion (in the middle of the downcomer 231) of the cyclone 220 of the circulating fluidized bed, and the feeding device 250 is connected to the extraction port in many cases.

The ore powder 501 supplied from the ore powder supply port 212 is fluidized by the supply gas that is supplied from the gas supply port 211 and rectified through a plurality of vent holes of the distributor 213. Specifically, inside the riser portion 210, the ore powder 501 is transported from below to above, passes through the cyclone 220 and the circulation line 230, and circulates through an inside of the circulating fluidized bed reduction apparatus 200. Therefore, the inside of the circulating fluidized bed reduction apparatus 200 is the circulating fluidized bed. The ore powder 501 stays for a while in the loop seal portion 232. The ore powder 501 is reduced to reduced iron by the supply gas while being fluidized mainly in the riser portion. In a case where the reduction reaction by the circulating fluidized bed reduction apparatus 200 is a batch type process, powder after the reduction process is extracted from, for example, an openable extraction port (not shown) provided in the lower portion (in the middle of the downcomer 231) of the cyclone 220. In a case where the reduction process is a continuous type, for example, a valve of an openable extraction port provided in the riser portion 210 is opened at regular time intervals or continuously, and the powder after the process is extracted, while the ore powder is supplied from the ore powder supply port 212.

### [Mean Residence Time]

A mean residence time of the ore powder 501 that stays in the circulating fluidized bed reduction apparatus 200 depends on the temperature of the reduction reaction, but is preferably 3 minutes or longer and 120 minutes or shorter. When the mean residence time is 3 minutes or longer, reduced iron having a high reduction degree can be obtained. On the other hand, when the mean residence time is 120 minutes or shorter, a processing efficiency of the reduction apparatus is maintained in a high level. In addition, when the mean residence time is 120 minutes or shorter, a decrease in crushing strength of the ore powder 501 due to the excessive progress of reduction, or a decrease in recovery efficiency of reduced iron due to pulverization of the ore powder 501 caused by collision between particles of the ore powder 501 or between the ore powder 501 and the apparatus during circulation is suppressed. Therefore, the mean residence time is preferably 120 minutes or shorter. The mean residence time of the ore powder 501 that stays in the circulating fluidized bed reduction apparatus 200 is more preferably 5 minutes or longer and 60 minutes or shorter. The mean residence time is adjusted by adjusting the amount of the ore powder 501 that is extracted from the extraction port per hour.

The mean residence time of the ore powder 501 can be calculated by the following method. That is, as tracer particles, for example, a certain amount of ore powder having the same median diameter but different gangue components is injected, and a change in a content of the gangue components of discharged reduced iron over time is investigated. A peak time zone thus obtained during which the content of the gangue components that feature the injected tracer ore powder is the highest is set as the mean residence time of the ore powder 501. From the above method, the mean residence time can be measured experimentally.

### (Bubbling Fluidized Bed Reduction Apparatus 300)

As shown in FIG. 16, the bubbling fluidized bed reduction apparatus 300 includes a reactor 310 and the dry dust collector 320.

In the bubbling fluidized bed reduction apparatus 300, for example, as shown in FIG. 15, a bubbling fluidized bed 500, which is a fluidized bed in which bubbles 502 caused by a gas are formed in a fluidized bed formed of the ore powder 501, is formed inside the reactor 310. The bubbles 502 have various morphologies depending on a fluidized state, and there are cases where clear bubbles are not formed depending on the fluidized state.

### [Reactor 310]

The reactor 310 includes, for example, as shown in FIG. 16, a gas supply port 311, an ore powder supply port 312, a distributor 313, and an outlet 314. The reactor 310 is basically the same as the riser portion 210 of the circulating fluidized bed reduction apparatus 200.

### [Bubbling Fluidized Bed 500]

The bubbling fluidized bed 500 is formed by fluidizing the ore powder 501 by a gas that is supplied from the gas supply port 311 and is rectified through a plurality of vent holes of the distributor 313. Similarly to the fluidized bed or the circulating fluidized bed in the granulation vessel 110 of the granulation apparatus 10, examples of a method and a form for ventilation of the gas for forming the bubbling fluidized bed 500 include, in addition to a flat plate type such as a porous plate or a slit plate for the distributor 313, a simple nozzle type, a cap type provided with a cap with various forms of blow holes at a nozzle tip, and a pipe type with grid tubes provided with a plurality of holes in a tube side surface, and specific forms thereof are not limited as long as the supply gas is supplied to the reactor 310 to allow the particles to be blown up and form a fluidized bed.

The ore powder 501 is the same as the ore powder used in the circulating fluidized bed reduction apparatus 200 and includes at least the granular powder that has been granulated by the granulation apparatus 10. The ore powder 501 is not limited to the granular powder granulated by the granulation apparatus 10 and may include, for example, fine powder ore having a particle size exhibiting a fluidizable property.

Examples of the supply gas supplied from the gas supply port 311 to an inside of the reactor 310 may include a reducing gas such as hydrogen gas, CO gas, and a synthetic gas (a mixed gas of carbon monoxide and hydrogen), a mixture of a reducing gas and an inert gas, and a combination of a reducing gas, an inert gas, and water vapor. The reducing gas is preferably hydrogen gas from the viewpoint of reducing the environmental burden.

A flow velocity of the supply gas depends on the particle size of the ore powder 501, but is, for example, 0.2 m/s or faster and slower than 1.0 m/s. The flow velocity of the supply gas supplied to the bubbling fluidized bed reduction apparatus 300 (gas superficial velocity) is slower than the flow velocity of the supply gas used in the circulating fluidized bed reduction apparatus 200, and the amount of ore powder jumping out of the bubbling fluidized bed 500 is extremely small. The flow velocity of the supply gas supplied to the bubbling fluidized bed reduction apparatus 300 is preferably 0.3 m/s or faster and 0.8 m/s or slower.

The flow velocity of the supply gas is a superficial velocity in the bubbling fluidized bed reduction apparatus 300 in which the bubbling fluidized bed 500 of the ore powder 501 is realized, is a value obtained by dividing a gas flow rate supplied per unit time by a cross-sectional area of a fluidized bed part of the reactor 310 of the bubbling fluidized bed reduction apparatus 300, and can be measured with a flow meter attached to a gas supply pipe.

In addition, the flow velocity of the supply gas of the circulating fluidized bed reduction apparatus 200 and the bubbling fluidized bed reduction apparatus 300 is preferably set to be faster than the flow velocity of the supply gas in the granulation apparatus 10. Accordingly, in each of the riser portion 210 of the circulating fluidized bed reduction apparatus 200 and the reactor 310 of the bubbling fluidized bed reduction apparatus 300, the ore powder is fluidized more violently than in the granulation apparatus 10 and thus does not adhere to each other, and further agglomeration of the ore powder beyond the particle size granulated in the granulation apparatus 10 can be suppressed. As a result, blockage of the riser portion 210 or the reactor 310 can be prevented, and high productivity can be maintained.

A reduction reaction temperature in the bubbling fluidized bed reduction apparatus 300 is preferably 500° C. or higher and 900° C. or lower. When the reduction reaction temperature in the bubbling fluidized bed reduction apparatus 300 is 500° C. or higher and 900° C. or lower, the reduction reaction of the ore powder 501 is promoted, and the manufacturability is improved. The reduction reaction temperature in the bubbling fluidized bed reduction apparatus 300 is more preferably 550° C. or higher from the viewpoint of improving the reduction rate of the ore powder 501 and efficiently obtaining reduced iron. In addition, the reduction reaction temperature in the bubbling fluidized bed reduction apparatus 300 is more preferably 850° C. or lower from the viewpoint of suppressing the excessive progress of agglomeration due to adhesion between the particles of the ore powders 501.

A mean residence time of the ore powder that stays in the bubbling fluidized bed reduction apparatus 300 is preferably 3 minutes or longer and 180 minutes or shorter. When the mean residence time is 3 minutes or longer, reduced iron having a high reduction degree can be obtained. On the other hand, when the mean residence time is 180 minutes or shorter, the processing efficiency of the reduction apparatus is maintained high. In addition, when the mean residence time is 180 minutes or shorter, a decrease in crushing strength of the ore powder due to the excessive progress of reduction, or a decrease in recovery efficiency of reduced iron due to pulverization of the ore powder 501 caused by collision between the particles of the ore powder 501 or between the ore powder 501 and the apparatus during circulation is suppressed. Therefore, the mean residence time is preferably 180 minutes or shorter. The mean residence time of the ore powder that stays in the bubbling fluidized bed reduction apparatus 300 is more preferably 5 minutes or longer and 150 minutes or shorter. The mean residence time is adjusted by adjusting the amount of the ore powder extracted from the extraction port per hour, as in the case of the circulating fluidized bed. The mean residence time can be measured by the same method as the method for measuring the mean residence time of the ore powder in the circulating fluidized bed reduction apparatus 200.

The ore powder 501 supplied from the ore powder supply port 312 is fluidized by the supply gas that is supplied from the gas supply port 311 and rectified through a plurality of vent holes of the distributor 313. Specifically, the ore powder 501 forms the bubbling fluidized bed 500 inside the reactor 310 and is reduced to reduced iron by the supply gas while being fluidized. The reduced iron is discharged from an openable reduced iron extraction port (not shown).

### [Modification Example of Reactor]

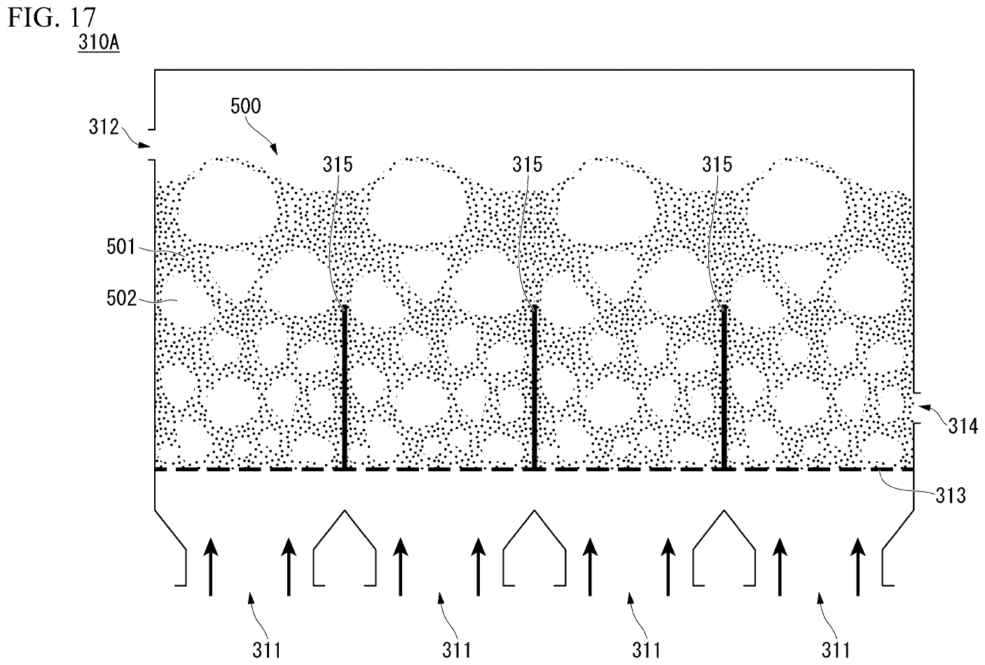

The above-described reactor 310 is a reactor that forms a single-stage bubbling fluidized bed 500. However, the reactor provided in the bubbling fluidized bed reduction apparatus 300 is not limited to the reactor 310, and may be, for example, a reactor 310A having a plurality of reduction chambers therein as shown in FIG. 17. FIG. 17 is a schematic diagram showing another example of the reactor of the bubbling fluidized bed reduction apparatus in the present embodiment.

The reactor 310A may include, for example, the ore powder supply port 312 provided on one side surface in a longitudinal direction, the outlet 314 provided on the other side surface in the longitudinal direction, and a plurality of the gas supply ports 311 parallel to each other in the longitudinal direction, the distributor 313 provided above each of the gas supply ports 311, and partition plates 315 provided between the gas supply ports 311 adjacent to each other. A space between the partition plates 315 adjacent to each other is the reduction chamber in which the ore powder 501 is reduced. A height of the partition plate 315 is shorter than a height of the bubbling fluidized bed 500. With the reactor 310A having such a configuration, the mean residence time of the ore powder can be lengthened, and an attained reduction degree can be increased. It is needless to say that an installation position of the ore powder supply port, the number of ore powder supply ports installed, an installation position of the outlet, the number of outlets installed, an installation position of the partition plate, and the number of partition plates installed are not limited to the aspect shown in FIG. 17 and may be changed as appropriate.

### [Dry Dust Collector 320]

The dry dust collector 320 collects fine powder contained in the off-gas. The dry dust collector 320 may have a configuration applicable to the dry dust collector 120. The dry dust collector 320 corresponds to the collecting device according to the present invention.

### Modification Example

The reduction apparatus 20 may be one circulating fluidized bed reduction apparatus 200, one bubbling fluidized bed reduction apparatus 300, a plurality of circulating fluidized bed reduction apparatuses 200, a plurality of bubbling fluidized bed reduction apparatuses 300, or a combination of one or more circulating fluidized bed reduction apparatuses 200 and one or more bubbling fluidized bed reduction apparatuses 300. In the circulating fluidized bed, since a difference (slip velocity) between an average flow velocity of the supply gas and an average movement velocity of the ore is large, a frequency of replacement of the reducing gas that comes into contact with the ore powder is high, and surroundings of the ore powder approach an equilibrium state, so that stagnation of the reduction reaction can be avoided, and the ore powder is efficiently reduced. On the other hand, since the average movement velocity of the ore powder itself is also high, mechanical wear or fracture occurs due to collision between the particles of the ore powder or the like, and dust is likely to be generated. In the bubbling fluidized bed, since the difference (slip velocity) between the average flow velocity of the supply gas and the average movement velocity of the ore is smaller than that of the circulating fluidized bed, a reduction efficiency of the ore powder by the bubbling fluidized bed is inferior to a reduction efficiency of the ore powder by the circulating fluidized bed. On the other hand, the generation of dust tends to be suppressed more than in the circulating fluidized bed. Furthermore, by suppressing the gas flow velocity, it is possible to suppress energy and cost for supplying the gas. A configuration of the reduction apparatus 20 is preferably determined in consideration of the characteristics of the circulating fluidized bed and the bubbling fluidized bed, the median diameter of the ore, an Fe content, and the like.

### <Configuration Example of Facility for Producing Reduced Iron>

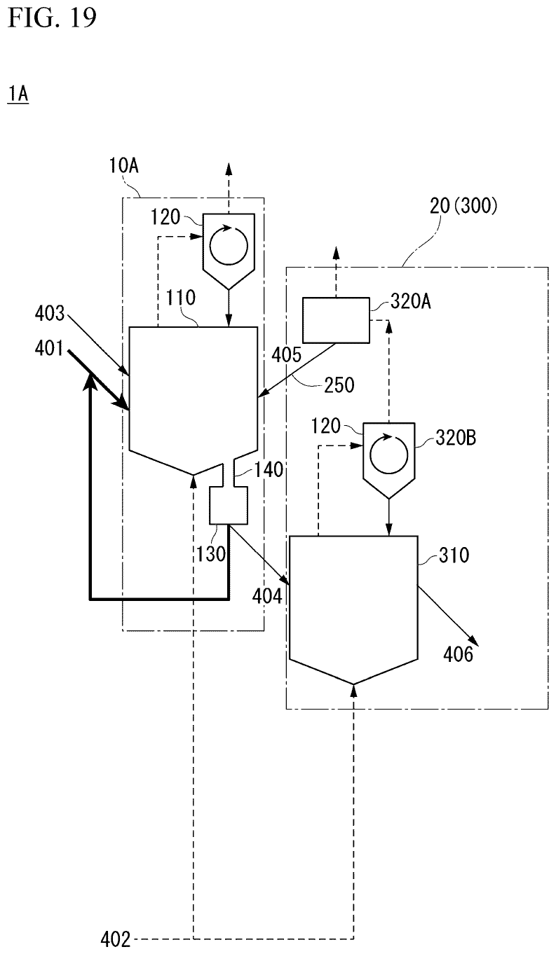

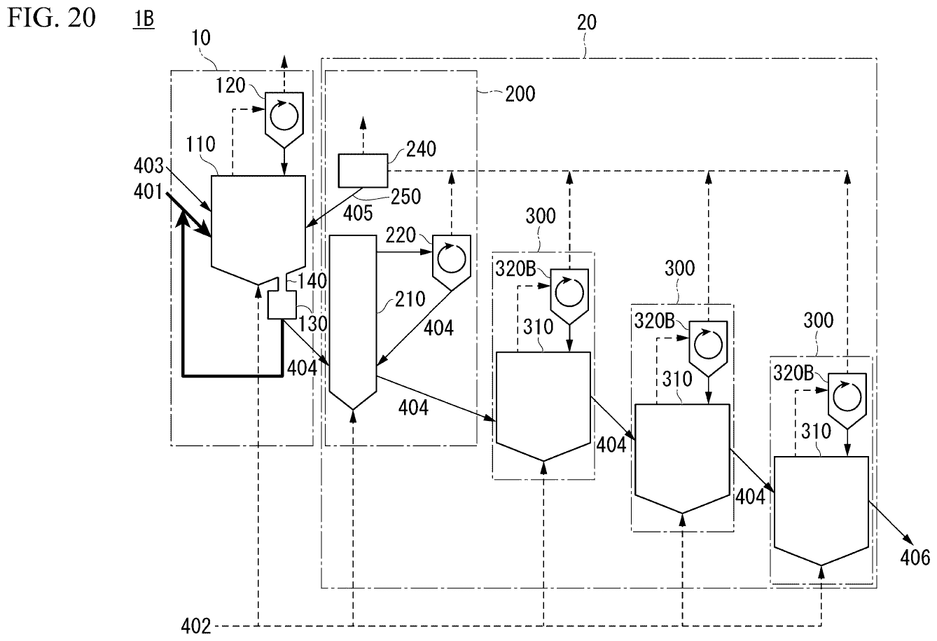

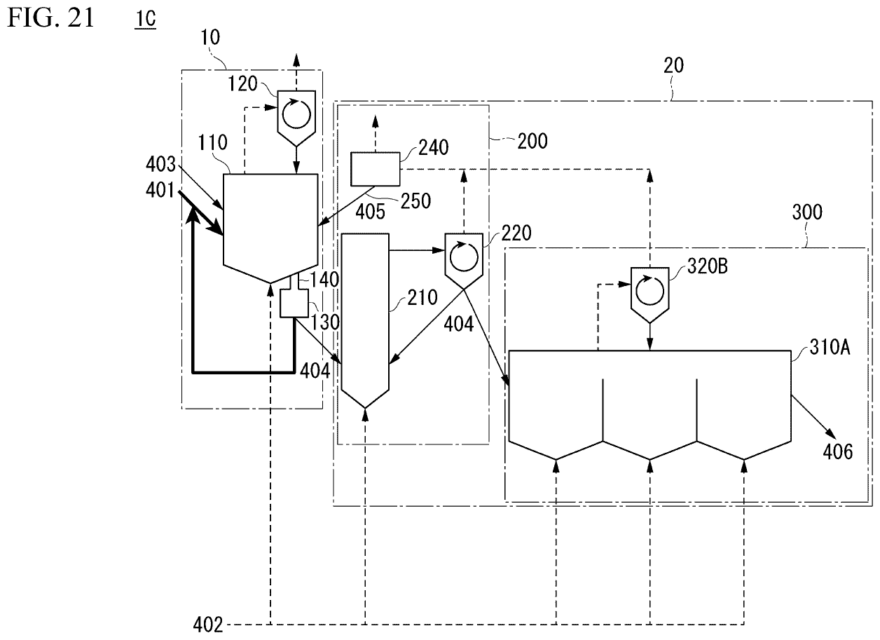

Here, configuration examples of the facility for producing reduced iron will be described with reference to FIGS. 18 to 21. FIG. 18 is a schematic configuration diagram showing an example of the facility for producing reduced iron provided with one circulating fluidized bed reduction apparatus 200 as the reduction apparatus 20. FIG. 19 is a schematic configuration diagram showing an example of the facility for producing reduced iron provided with one bubbling fluidized bed reduction apparatus 300 as the reduction apparatus 20. FIG. 20 is a schematic configuration diagram showing an example of the facility for producing reduced iron provided with one circulating fluidized bed reduction apparatus 200 and three bubbling fluidized bed reduction apparatuses 300 as the reduction apparatus 20. FIG. 21 is a schematic configuration diagram showing an example of the facility for producing reduced iron including one circulating fluidized bed reduction apparatus 200 and one bubbling fluidized bed reduction apparatus 300 having a plurality of reduction chambers as the reduction apparatus 20. Solid arrows in FIGS. 18 to 21 indicate flows of powder, and broken arrows indicate flows of gas.

### First Configuration Example

A facility 1 for producing reduced iron shown in FIG. 18 includes the granulation apparatus 10, and one circulating fluidized bed reduction apparatus 200 as the reduction apparatus 20. For example, in the facility 1 for producing reduced iron shown in FIG. 18, reduced iron is produced as follows. First, in the granulation apparatus 10, the medium particles 401 are charged into the granulation vessel 110, and the supply gas 402 is supplied from below the granulation vessel 110. The medium particles 401, together with the supply gas 402, form the particulate fluidized bed 400 inside the granulation vessel 110. The raw material fine powder 403 is supplied to the granulation vessel 110 and is agglomerated by the particulate fluidized bed 400, so that a granular powder 404 is granulated.

A mixture of the granular powder 404 and the medium particles 401 is transported to the granular powder separation device 130 via the transporting device 140, and is separated into the granular powder 404 and the medium particles 401 by the granular powder separation device 130. The separated medium particles 401 are charged into the granulation vessel 110 again. The granular powder 404 is supplied to the riser portion 210 of the circulating fluidized bed reduction apparatus 200 through the ore powder supply port 212 or the downcomer 231 via a pipe.

On the other hand, the raw material fine powder 403 discharged from the outlet of the granulation vessel 110 together with the supply gas 402 is collected by the dry dust collector 120 and supplied to the granulation vessel 110 again.

The granular powder 404 supplied to the riser portion 210 forms a circulating fluidized bed with the supply gas 402 supplied from below the riser portion 210. The granular powder 404 is reduced to reduced iron 406 in the circulating fluidized bed by the supply gas 402. The gas including the granular powder 404 and dust 405 newly generated in the circulating fluidized bed is separated by the cyclone 220, and the granular powder 404 is fed into the riser portion 210 again. The off-gas including the dust 405 is sent to the dry dust collector 240. The dust 405 is separated from the off-gas by the dry dust collector 240, recovered, and supplied to the granulation vessel 110 as return raw material fine powder (raw material fine powder 403) through the feeding device 250.

As described above, the reduced iron can be produced by, for example, the facility for producing reduced iron provided with the granulation apparatus 10 and one circulating fluidized bed reduction apparatus 200 as the reduction apparatus 20.

### Second Configuration Example

A facility 1A for producing reduced iron shown in FIG. 19 includes the granulation apparatus 10A and one bubbling fluidized bed reduction apparatus 300 as the reduction apparatus 20. For example, in the facility 1A for producing reduced iron shown in FIG. 19, the reduced iron 406 is produced as follows. A process until the granular powder 404 and the medium particles 401 are separated from each other by the granular powder separation device 130 and the medium particles 401 are charged into the granulation vessel 110 again is the same as the example described using FIG. 18, so that description thereof will be omitted.

The granular powder 404 is supplied to the reactor 310 of the bubbling fluidized bed reduction apparatus 300. The granular powder 404 supplied to the reactor 310 forms the bubbling fluidized bed 500 in the reactor 310 with the supply gas 402 supplied from below the reactor 310. The granular powder 404 is reduced to the reduced iron 406 in the bubbling fluidized bed 500. The off-gas including the dust 405 is sent to a dry dust collector 320A via a dry dust collector 320B. The dust 405 is separated from the off-gas by the dry dust collector 320A, recovered, and supplied to the granulation vessel 110 as return raw material fine powder (raw material fine powder 403). As shown in FIG. 19, the bubbling fluidized bed reduction apparatus 300 may have a plurality of dry dust collectors 320, for example, the dry dust collectors 320A and 320B. Accordingly, types of powder having different particle sizes can be respectively recovered. Therefore, in the dry dust collector 320B, it is also possible to recover the granular powder 404 that may be included in the off-gas. The granular powder 404 recovered by the dry dust collector 320B is fed into the reactor 310 again through the feeding device 250.

As described above, the reduced iron can be produced by, for example, the facility for producing reduced iron including the granulation apparatus 10A and one bubbling fluidized bed reduction apparatus 300 as the reduction apparatus 20.

### Third Configuration Example

A facility 1B for producing reduced iron shown in FIG. 20 includes the granulation apparatus 10, and as the reduction apparatus 20, one circulating fluidized bed reduction apparatus 200 and three bubbling fluidized bed reduction apparatuses 300. For example, in the facility 1B for producing reduced iron shown in FIG. 20, the reduced iron 406 is produced as follows. A process until the granular powder 404 and the medium particles 401 are separated from each other by the granular powder separation device 130 and the medium particles 401 are charged into the granulation vessel 110 again is the same as the example described using FIG. 18, so that description thereof will be omitted.

The granular powder 404 is supplied to the riser portion 210 of the circulating fluidized bed reduction apparatus 200. The reduction of the granular powder 404 supplied to the riser portion 210 progresses due to the supply gas 402 in the circulating fluidized bed. Partially reduced granular powder 404 is fed into the reactor 310 in a first stage of the bubbling fluidized bed reduction apparatus 300, the reduction of the granular powder 404 progresses in the bubbling fluidized bed 500 formed of the granular powder 404 and the supply gas 402 in the reactor 310. The granular powder 404 in the reactor 310 is sequentially supplied to the reactor 310 in a second stage and the reactor 310 in a third stage and is reduced. The granular powder 404 is finally reduced to reduced iron 406 in the bubbling fluidized bed 500 in the reactor 310 in the third stage.

The dry dust collector 320B connected to each of the reactors 310 recovers the granular powder 404 that may be included in the off-gas, and the recovered granular powder 404 is fed into each of the reactors 310 again.

The off-gas including the dust 405 separated by the cyclone 220 of the circulating fluidized bed reduction apparatus 200 and by the dry dust collector 320B of the bubbling fluidized bed reduction apparatus 300 is sent to the dry dust collector 240. The dust 405 separated from the off-gas by the dry dust collector 240 and recovered is supplied to the granulation vessel 110 again as return raw material fine powder (raw material fine powder 403) through the feeding device 250.

As described above, for example, the reduced iron can be produced by, for example, the facility for producing reduced iron including one circulating fluidized bed reduction apparatus 200 and three bubbling fluidized bed reduction apparatuses 300 as the reduction apparatus 20. According to the reduction apparatus 20 in which the bubbling fluidized bed reduction apparatus 300 is provided at a rear stage of the circulating fluidized bed reduction apparatus 200, a reduction time can be shorted in an initial stage of reduction in which the reduction reaction tends to rapidly progress due to limited supply of the reducing gas reaching the surfaces of the particles of the ore powder, and excessive use of the reducing gas can be omitted in a later stage of reduction in which the reduction rate becomes limited by diffusion of substances inside the ore and the reduction rate tends to stagnate. In addition, by providing multiple stages of the bubbling fluidized bed reduction apparatus 300, the mean residence time of the ore powder can be secured while suppressing variations in the residence time, so that reduced iron with a desired attained reduction degree can be obtained with less variation in quality.

### Fourth Configuration Example

A facility 1C for producing reduced iron shown in FIG. 21 includes the granulation apparatus 10 and, as the reduction apparatuses 20, one circulating fluidized bed reduction apparatus 200 and one bubbling fluidized bed reduction apparatus 300 having a plurality of reduction chambers therein. For example, in the facility 1C for producing reduced iron shown in FIG. 21, the reduced iron 406 is produced as follows. A process until the partially reduced granular powder 404 in the circulating fluidized bed reduction apparatus 200 is reduced by the supply gas 402 is the same as the example described using FIG. 20, so that description thereof will be omitted.

The partially reduced granular powder 404 is charged into the reactor 310A having a plurality of reduction chambers therein in the bubbling fluidized bed reduction apparatus 300. The granular powder 404 moves in the plurality of reduction chambers of the reactor 310A. The granular powder 404 is reduced to the reduced iron 406 by the bubbling fluidized bed formed in each of the reduction chambers in the reactor 310A. The dry dust collector 320B connected to the reactor 310A and the dry dust collector 240 are the same as those shown in FIG. 9. In addition, the dust 405 separated from the off-gas by the dry dust collector 240 through the cyclone 220 and the dry dust collector 320B and recovered is supplied to the granulation vessel 110 as return raw material fine powder (raw material fine powder 403) through the feeding device 250.

As described above, for example, by the facility for producing reduced iron provided with one circulating fluidized bed reduction apparatus 200 and one bubbling fluidized bed reduction apparatus 300 as the reduction apparatus 20, the mean residence time of the ore powder can be secured while suppressing variations in the residence time as in the multiple stages of the bubbling fluidized bed in FIG. 9, so that reduced iron with a desired attained reduction degree can be obtained with less variation in quality.

In addition, although not shown in FIGS. 18 to 21, in addition to the granular powder 404, for example, fine powder ore having a median diameter of 50 μm or more, which is a particle size exhibiting a fluidizable property, may be supplied to the riser portion 210 and the reactors 310 and 310A.

The reduction degree of the reduced iron obtained by the reduction apparatus 20 is set according to the purpose of the process. In a case where this process is used as a general method for producing reduced iron for refinement in an electric furnace, the attained reduction degree is preferably 90% or more. When the reduction degree is 90% or more, a final product of reduced iron can be provided to, for example, a user who performs refinement in the electric furnace. Furthermore, in a case where the purpose is to inject reduced iron as a raw material in a blast furnace and lower a usage rate of reducing materials such as coke in the blast furnace, a attained reduction degree of a semi-reduced iron product does not need to exceed 90%, and the attained reduction degree may be, for example, about 70%. The reduction degree of the reduced iron can be calculated in the same manner as the reduction degree of the granular powder.

In the method for producing reduced iron according to the present embodiment, fine powder exhibiting a hardly fluidizable property can be granulated into the granular powder having a fluidizable property using the fluidized bed in the granulation process, and the reduced iron can be produced from the granular powder using the fluidized bed in the reduction process. Therefore, reduced iron can be produced at a high yield. In addition, in the method for producing reduced iron according to the present embodiment, there is no need to perform pelletization in the related art, and thus reduced iron can be produced at low cost. In addition, since the granulation apparatus and the reduction apparatus are not complex, a facility introduction cost is also low.

Furthermore, the granulation apparatus, the circulating fluidized bed reduction apparatus, and the bubbling fluidized bed reduction apparatus shown in the drawings are merely examples, and it is needless to say that the granulation apparatus, the circulating fluidized bed reduction apparatus, and the bubbling fluidized bed reduction apparatus according to the present embodiment are not limited to the aspects shown in the drawings. For example, the granulation vessel may have a supply line coaxial with the granulation vessel inside the granulation vessel, and the raw material fine powder may be fed into the granulation vessel from this supply line. The same applies to the reactors included in the reduction apparatus.

### EXAMPLES

Next, examples of the present invention will be described, but conditions in the examples are one example of conditions adopted to confirm the feasibility and effect of the present invention, and the present invention is not limited to the conditions used in the following examples. The present invention may adopt various conditions to achieve the object of the present invention without departing from the scope of the present invention.

Granular powder was obtained by granulating raw material fine powder under the conditions shown in Tables 1 to 3. Examples Nos. A8 to A10 are examples in which a granulation process was not performed. The volume ratios shown in Tables 1 to 3 mean a ratio of a volume of the raw material fine powder to a total volume including medium particles.

Median diameters of the raw material fine powder, the medium particles, and the granular powder were measured by the following methods. That is, a laser diffraction type particle size measuring device (Mastersizer 3000 manufactured by Malvern Panalytical Ltd), which is a wet type measuring device, was used, a dispersion medium was set to water, a dispersion medium refractive index was set to 1.33, a particle refractive index for the raw material fine powder and the granular powder was set to 2.918, and a particle refractive index for the medium particles was set according to the medium particles used. For example, in a case where the medium particle is SiO₂, the refractive injex is 1.55. Each powder was split into 100 g by a sample splitter capable of splitting the injected powder into equal parts, and then extracted up to 2 g by a coning and quartering method. A particle size of the powder randomly sampled therefrom was measured by the laser diffraction type particle size measuring device, and an average value of volume-based particle sizes d₅₀ in the measured undersize cumulative distribution measured was used as the median diameter.

The volume of the raw material fine powder to the total volume of the particles including the medium particles was measured by the following method. That is, bulk densities of the medium particles and the raw material fine powder in a dried state were measured, and weights with which predetermined volume ratios were achieved were obtained from the bulk densities and injected. The bulk density was measured using POWDER TESTER PT-X (manufactured by HOSOKAWA MICRON B.V.), the bulk density was measured in a loose bulk density measurement mode, and the injected weight was derived.

A mean residence time of ore powder was calculated by the following method. That is, as ore powder having the same median diameter as the raw material fine powder but different gangue components as tracer particles, ore including Mg at a component concentration of five times or more in terms of chemical analysis values was prepared. This was injected into a feeder that continuously injects the raw material fine powder. At this time, in a state where a certain material flow was realized, in which the raw material fine powder was discharged as reduced iron, a change over time in a content of the gangue component Mg of the reduced iron discharged while the apparatus was continuously operated as it was investigated. A peak time zone thus obtained during which the content of the gangue component Mg that featured the injected tracer ore powder was the highest is set as the mean residence time.

A reduction degree was measured by the following method. That is, about 0.1 g of the granular powder after the granulation process or reduced powder after a reduction process was weighed into a quartz cell in a glove box having a nitrogen atmosphere, and immersed in benzene to avoid contact of the granular powder or the reduced powder after the reduction process with the air. The quartz cell was installed in a thermobalance (manufactured by SHINKU-RIKO Inc., TGD7000), and the system was evacuated. Thereafter, nitrogen was flowed at 2.00×10⁻⁴ m³/min and a temperature was raised to 200° C. at a temperature rising rate of 20° C./min to evaporate the benzene. Then, the temperature was raised to 700° C. at a temperature rising rate of 3° C./s. After the temperature and the balance were stabilized, oxygen was introduced into the system and was held until there was no further increase in weight. Thereafter, the inside of the system was cooled to 100° C. or lower, evaluated, and purged with nitrogen, and the temperature was raised again to 700° C. at a temperature rising rate of 20° C./min. Next, hydrogen gas was flowed at 2.00×10⁻⁴ m³/min and was held until a change in weight was not recognized. The reduction degree was obtained from Formula (3) based on a change in weight.

$$X = \{ ( {m}_{Fe 2 O 3} - {m}_{sample} ) - 0.329 \times ( {m}_{Fe 2 O 3} - {m}_{Fe} ) \} / \{ 0.671 \times ( ( {m}_{Fe 2 O 3} - {m}_{Fe} ) \} \qquad Formula ( 3 )$$

Here, in the formula, X is the reduction degree (%), m_{Fe2O3} is the weight of the granular powder after oxidation or the reduced powder (the weight of the granular powder or the reduced powder when there was no further increase in weight after the introduction of oxygen), mₛₐₘₚₗₑ is a mass of the granular powder or the reduced powder, and m_{Fe} is the weight of the granular powder or the reduced powder after being held in hydrogen gas (the weight of the granular powder or the reduced powder when there was no further increase in weight after the introduction of hydrogen gas). Chemical forms of the granular powder and the reduced powder after oxidation and after being held in hydrogen gas by the thermobalance can be verified as Fe₂O₃ and Fe, respectively, by X-ray diffraction.

A pressure measurement terminal was introduced into a portion below a distributor in a granulation vessel and a freeboard portion above a part where the particles are fluidized, a pressure loss therebetween was measured. A case where the measured pressure loss was used as a monitoring index in the granulation process was indicated as “Present” of pressure loss monitoring, and a case where the measurement of the pressure loss was omitted was indicated as “Absent” in Tables 1 to 3.

Regarding a cross-sectional area of a horizontal cross section, a case where a shape of the granulation vessel was a tapered shape with an expanded upper portion so that a cross-sectional area of the freeboard portion above a particulate fluidized bed was larger than a cross-sectional area at a random position of the particulate fluidized bed was indicated as “Present” of vessel shape upper expanded taper, and a case where the cross-sectional area of the freeboard portion above the particulate fluidized bed was smaller or a case where the shape of the granulation vessel was a straight shape with no expansion and had the same cross-sectional area was indicated as “Absent” in Tables 1 to 3.

Regarding a part by which granules were separated and extracted from the granulation apparatus, in the column of granule separation step in Tables 1 to 3, in examples indicated as “Dry sieve”, as described above, a first sieve inclined to one side was disposed on an upper side, and a second sieve that was inclined to a side opposite to the inclination direction of the first sieve and had a smaller mesh size than that of the first sieve was disposed at a position below the first sieve. The second sieve was inclined so that the powder captured by the second sieve could fall into a transportation pipe on the reduction apparatus side. Through the two sieves having different mesh sizes disposed on the upper and lower sides, the sieve on the upper side was inclined to one side, and the sieve on the lower side was disposed to be inclined to the side opposite to the sieve on the upper side. Furthermore, the sieve on the upper side captured the medium particles as the coarse particles but allowed the granular powder and the raw material fine powder having smaller particle sizes to be passed therethrough, and the sieve on the lower side captured the granular powder but allowed the raw material fine powder to be passed therethrough, so that the granular powder captured only by the sieve on the lower side could fall into the transportation pipe on the reduction apparatus side. In addition, in the examples described as “Magnetic separation”, a mechanism was provided to cause the powder extracted from the granulation apparatus to fall, and a magnetic force was applied from the outside so as to allow the powder to fall from the outside of the pipe into which the powder had to fall to the transportation pipe. In the examples described as “Pneumatic classification”, nitrogen gas was applied at a constant velocity from a horizontal direction while allowing the powder to fall similarly to allow only the granular powder to fall into the transportation pipe on the reduction apparatus side. In the examples described as “Sedimentation classification”, the extracted powder was fluidized with nitrogen gas in a separate vessel, and a flow velocity of the gas at this time was set to be equal to or faster than a minimum fluidization velocity of the raw material fine powder and slower than a minimum fluidization velocity of the medium particles to cause the medium particles to settle in the fluidized bed, thereby enabling sequential discharge of the medium particles from a lowermost portion and the granular powder from a middle portion, and achieving separation. The magnetic separation of the granules using magnetite concentrate as a raw material was used in combination with a dry sieve in order to increase separation efficiency.

TABLE 1

| | Granulation process | | | | | | | |
|---|---|---|---|---|---|---|---|---|
| | | | | | Volume | | | |
| | Raw material | | Medium | | ratio of | | | |
| | fine powder | | particles | | raw | Supply gas | | |
| | | Median | | Median | material | | Flow | |
| | | diameter | | diameter | fine powder | Gas | velocity | Temperature |
| No. | Type | (μm) | Type | (μm) | (volume %) | type | (m/s) | (° C.) |
| A1 | Magnetite | 18 | SiO₂ | 0.30 | 10 | Air | 0.05 | 1120 |
| | concentrate | | | | | | | |
| A2 | Pellet feed | 23 | SiO₂ | 0.30 | 10 | H₂ | 0.05 | 720 |
| | (hematite ore) | | | | | | | |
| A3 | Sinter feed | 28 | SiO₂ | 0.30 | 10 | H₂ | 0.05 | 720 |
| | (pisolite ore) | | | | | | | |
| A4 | Sinter feed | 28 | SiO₂ | 0.30 | 10 | H₂ | 0.05 | 720 |
| | (pisolite ore) | | | | | | | |
| A5 | Sinter feed | 28 | SiO₂ | 0.30 | 10 | H₂ | 0.05 | 720 |
| | (pisolite ore) | | | | | | | |
| A6 | Sinter feed | 28 | SiO₂ | 0.30 | 10 | H₂ | 0.05 | 720 |
| | (pisolite ore) | | | | | | | |
| A7 | Sinter feed | 28 | SiO₂ | 0.30 | 10 | H₂ | 0.05 | 720 |
| | (pisolite ore) | | | | | | | |
| A8 | Sinter feed | 28 | — | — | — | — | — | — |
| | (pisolite ore) | | | | | | | |
| A9 | Sinter feed | 28 | — | — | — | — | — | — |
| | (pisolite ore) | | | | | | | |
| A10 | Sinter feed | 28 | — | — | — | — | — | — |
| | (pisolite ore) | | | | | | | |
| A11 | Magnetite | 18 | SiO₂ | 0.30 | 10 | Air | 0.05 | 1120 |
| | concentrate | | | | | | | |

| | Granulation process | | | | | |
|---|---|---|---|---|---|---|
| | | Granular powder | | | Vessel | |
| | Mean | Median | Reduction | Pressure | shape upper | Granule |
| | residence | diameter | degree | loss | expanded | separation |
| No. | time (min) | (μm) | (%) | monitoring | taper | step |
| A1 | 20 | 0.07 | — | Present | Present | Dry sieve |
| A2 | 5 | 0.06 | H | Present | Present | Dry sieve |
| A3 | 10 | 0.06 | G | Present | Present | Dry sieve |
| A4 | 10 | 0.06 | G | Present | Present | Dry sieve |
| A5 | 10 | 0.06 | G | Present | Present | Dry sieve |
| A6 | 10 | 0.06 | G | Present | Present | Dry sieve |
| A7 | 10 | 0.06 | G | Present | Present | Dry sieve |
| A8 | — | — | — | — | — | — |
| A9 | — | — | — | — | — | — |
| A10 | — | — | — | — | — | — |
| A11 | 20 | 0.07 | — | Present | Present | Magnetic |
| | | | | | | separation + |
| | | | | | | dry sieve |

TABLE 2

| | Granulation process | | | | | | | |
|---|---|---|---|---|---|---|---|---|
| | | | | | Volume | | | |
| | Raw material | | Medium | | ratio of | | | |
| | fine powder | | particles | | raw | Supply gas | | |
| | | Median | | Median | material | | Flow | |
| | | diameter | | diameter | fine powder | Gas | velocity | Temperature |
| No. | Type | (μm) | Type | (μm) | (volume %) | type | (m/s) | (° C.) |
| A12 | Sinter feed | 30 | SiO₂ | 0.30 | 10 | H₂ | 0.05 | 720 |
| | (pisolite ore) | | | | | | | |
| A13 | Sinter feed | 50 | SiO₂ | 0.30 | 10 | H₂ | 0.05 | 720 |
| | (pisolite ore) | | | | | | | |
| A14 | Sinter feed | 110 | SiO₂ | 0.30 | 10 | H₂ | 0.05 | 720 |
| | (pisolite ore) | | | | | | | |
| A15 | Sinter feed | 200 | SiO₂ | 0.30 | 10 | H₂ | 0.05 | 720 |
| | (pisolite ore) | | | | | | | |
| A16 | Sinter feed | 28 | SiC | 0.30 | 10 | H₂ | 0.06 | 720 |
| | (pisolite ore) | | | | | | | |
| A17 | Sinter feed | 28 | ZrO₂ | 0.30 | 10 | H₂ | 0.06 | 720 |
| | (pisolite ore) | | | | | | | |
| A18 | Sinter feed | 28 | Si₃N₄ | 0.30 | 10 | H₂ | 0.06 | 720 |
| | (pisolite ore) | | | | | | | |
| A19 | Sinter feed | 28 | MgO | 0.30 | 10 | H₂ | 0.07 | 720 |
| | (pisolite ore) | | | | | | | |
| A20 | Sinter feed | 28 | Al₂O₃ | 0.30 | 10 | H₂ | 0.06 | 720 |
| | (pisolite ore) | | | | | | | |
| A21 | Sinter feed | 28 | SiO₂ | 0.10 | 10 | H₂ | 0.04 | 720 |
| | (pisolite ore) | | | | | | | |
| A22 | Sinter feed | 28 | SiO₂ | 0.20 | 10 | H₂ | 0.05 | 720 |
| | (pisolite ore) | | | | | | | |
| A23 | Sinter feed | 28 | SiO₂ | 0.60 | 10 | H₂ | 0.05 | 720 |
| | (pisolite ore) | | | | | | | |
| A24 | Sinter feed | 28 | SiO₂ | 0.80 | 10 | H₂ | 0.07 | 720 |
| | (pisolite ore) | | | | | | | |
| A25 | Sinter feed | 28 | SiO₂ | 1.20 | 10 | H₂ | 0.10 | 720 |
| | (pisolite ore) | | | | | | | |
| A26 | Sinter feed | 28 | SiO₂ | 0.30 | 20 | H₂ | 0.05 | 720 |
| | (pisolite ore) | | | | | | | |
| A27 | Sinter feed | 28 | SiO₂ | 0.30 | 30 | H₂ | 0.05 | 720 |
| | (pisolite ore) | | | | | | | |
| A28 | Sinter feed | 28 | SiO₂ | 0.30 | 50 | H₂ | 0.05 | 720 |
| | (pisolite ore) | | | | | | | |

| | Granulation process | | | | | |
|---|---|---|---|---|---|---|
| | | Granular powder | | | Vessel | |
| | Mean | Median | Reduction | Pressure | shape upper | Granule |
| | residence | diameter | degree | loss | expanded | separation |
| No. | time (min) | (μm) | (%) | monitoring | taper | step |
| A12 | 10 | 0.06 | G | Present | Present | Dry sieve |
| A13 | 10 | 0.08 | G | Present | Present | Dry sieve |
| A14 | — | — | — | Present | Present | Dry sieve |
| A15 | — | — | — | Present | Present | Dry sieve |
| A16 | 10 | 0.06 | G | Present | Present | Dry sieve |
| A17 | 10 | 0.06 | G | Present | Present | Dry sieve |
| A18 | 10 | 0.06 | G | Present | Present | Dry sieve |
| A19 | 10 | 0.06 | G | Present | Present | Dry sieve |
| A20 | 10 | 0.06 | G | Present | Present | Dry sieve |
| A21 | 10 | 0.06 | G | Present | Present | Dry sieve |
| A22 | 10 | 0.06 | G | Present | Present | Dry sieve |
| A23 | 10 | 0.06 | G | Present | Present | Dry sieve |
| A24 | 10 | 0.06 | G | Present | Present | Dry sieve |
| A25 | 10 | 0.06 | G | Present | Present | Dry sieve |
| A26 | 10 | 0.06 | G | Present | Present | Dry sieve |
| A27 | 10 | 0.06 | G | Present | Present | Dry sieve |
| A28 | 10 | 0.06 | G | Present | Present | Dry sieve |

TABLE 3

| | Granulation process | | | | | | | |
|---|---|---|---|---|---|---|---|---|
| | | | | | Volume | | | |
| | Raw material | | Medium | | ratio of | | | |
| | fine powder | | particles | | raw | Supply gas | | |
| | | Median | | Median | material | | Flow | |
| | | diameter | | diameter | fine powder | Gas | velocity | Temperature |
| No. | Type | (μm) | Type | (μm) | (volume %) | type | (m/s) | (° C.) |
| A29 | Sinter feed | 28 | SiO₂ | 0.30 | 10 | H₂ | 0.05 | 720 |
| | (pisolite ore) | | | | | | | |
| A30 | Sinter feed | 28 | SiO₂ | 0.30 | 10 | H₂ | 0.05 | 720 |
| | (pisolite ore) | | | | | | | |
| A31 | Sinter feed | 28 | SiO₂ | 0.30 | 10 | H₂ | 0.05 | 720 |
| | (pisolite ore) | | | | | | | |
| A32 | Sinter feed | 28 | SiO₂ | 0.30 | 10 | H₂ | 0.05 | 720 |
| | (pisolite ore) | | | | | | | |
| A33 | Sinter feed | 30 | SiO₂ | 0.30 | 10 | H₂ | 0.05 | 720 |
| | (pisolite ore) | | | | | | | |
| A34 | Sinter feed | 30 | SiO₂ | 0.30 | 10 | H₂ | 0.05 | 720 |
| | (pisolite ore) | | | | | | | |
| A35 | Sinter feed | 30 | SiO₂ | 0.30 | 10 | H₂ | 0.05 | 720 |
| | (pisolite ore) | | | | | | | |
| A36 | Sinter feed | 30 | SiO₂ | 0.30 | 10 | H₂ | 0.05 | 720 |
| | (pisolite ore) | | | | | | | |
| A37 | Sinter feed | 30 | SiO₂ | 0.30 | 10 | H₂ | 0.05 | 720 |
| | (pisolite ore) | | | | | | | |

| | Granulation process | | | | | |
|---|---|---|---|---|---|---|
| | | Granular powder | | | Vessel | |
| | Mean | Median | Reduction | Pressure | shape upper | Granule |
| | residence | diameter | degree | loss | expanded | separation |
| No. | time (min) | (μm) | (%) | monitoring | taper | step |
| A29 | 15 | 0.08 | G | Present | Present | Dry sieve |
| A30 | 20 | 0.10 | G | Present | Present | Dry sieve |
| A31 | 30 | 0.18 | E | Present | Present | Dry sieve |
| A32 | 10 | 0.06 | G | Present | Present | Dry sieve |
| A33 | 10 | 0.06 | G | Absent | Present | Dry sieve |
| A34 | 10 | 0.06 | G | Present | Absent | Dry sieve |
| A35 | 10 | 0.06 | G | Present | Present | Pneumatic |
| | | | | | | classification |
| A36 | 10 | 0.06 | G | Present | Present | Magnetic |
| | | | | | | separation + |
| | | | | | | pneumatic |
| | | | | | | classification |
| A37 | 10 | 0.06 | G | Present | Present | Sedimentation |
| | | | | | | separation |

The obtained granular powder or a mixed powder of the granular powder and ore powder was reduced under the conditions shown in Tables 4 to 6. In Tables 4 to 6, in a case of a reduction tank having two stages of fluidized beds, flow velocities of the reducing gas in the first and second stages are shown. The residence times shown in Tables 4 to 6 are the total time during which the granular powder had stayed in a riser portion having a circulating fluidized bed or a reactor having a bubbling fluidized bed provided in the reduction apparatus.

In addition, presence or absence of dust circulation shown in Tables 4 to 6 indicates whether or not dust generated in the fluidized bed was recovered and fed into the granulation apparatus again, and “Present” means that the dust was fed into the granulation apparatus again, while “Absent” means that the dust was not fed into the granulation apparatus again. In Examples Nos. B7, B12, B13, and B16 to B37, dust generated from each of the vessels having the circulating fluidized bed and the bubbling fluidized bed was recovered. In addition, for the recovery of dust, a multiclone formed of a small cyclone was used as a dry dust collecting device.

A yield was calculated as follows. That is, a ratio of a total mass of iron contained in the reduced iron obtained per unit time to a total mass of iron contained in the ore powder subjected to the reduction process per unit time in a stable consecutive processing state (%) was set as the yield.

The reduction degree is described in Tables 1 to 6 as follows. A reduction degree evaluated as E or higher can be considered a high reduction degree.
“A”: 90% or more and 95% or less
“B”: 85% or more and less than 90%
“C”: 80% or more and less than 85%
“D”: 75% or more and less than 80%
“E”: 70% or more and less than 75%
“F”: 60% or more and less than 70%
“G”: 50% or more and less than 60%
“H”: 40% or more and less than 50%

The yield is described in Tables 4 to 6 as follows. A yield evaluated as F or higher can be considered a high yield.
“A”: 98% or more
“B”: 95% or more and less than 98%
“C”: 90% or more and less than 95%
“D”: 80% or more and less than 90%
“E”: 70% or more and less than 80%
“F”: 60% or more and less than 70%

TABLE 4

| | Reduction process | | | | | | | | | | |
|---|---|---|---|---|---|---|---|---|---|---|---|
| | | | Reducing gas | | | | | | | | |
| | | | | Flow velocity | | | | Presence or | | | |
| | | | | (m/s) | | | Residence | absence of | | Reduction | |
| | Ore | | Gas | First | Second | Temperature | time | dust | Yield | degree | |
| No. | powder | Fluidized bed | type | stage | stage | (° C.) | (min) | circulation | (%) | (%) | Note |
| B1 | A1 | One stage of | H₂ | 5 | — | 700 | 20 | Absent | B | E | Present |
| | | circulating fluidized | | | | | | | | | Invention |
| | | bed | | | | | | | | | Example |
| B2 | A2 | One stage of | H₂ | 5 | — | 700 | 20 | Absent | B | D | Present |
| | | circulating fluidized | | | | | | | | | Invention |
| | | bed | | | | | | | | | Example |
| B3 | A3 | One stage of | H₂ | 5 | — | 700 | 20 | Absent | B | C | Present |
| | | circulating fluidized | | | | | | | | | Invention |
| | | bed | | | | | | | | | Example |
| B4 | A4 | One stage of | H₂ | 5 | 0.5 | 700 | 100 | Absent | B | B | Present |
| | | circulating fluidized | | | | | | | | | Invention |
| | | bed + one stage of | | | | | | | | | Example |
| | | bubbling fluidized | | | | | | | | | |
| | | bed | | | | | | | | | |
| B5 | A5 | Two stages of | H₂ | 0.5 | 0.5 | 700 | 120 | Absent | B | B | Present |
| | | bubbling fluidized | | | | | | | | | Invention |
| | | bed | | | | | | | | | Example |
| B6 | A6 | One stage of | H₂ | 5 | — | 700 | 20 | Present | A | C | Present |
| | | circulating fluidized | | | | | | | | | Invention |
| | | bed | | | | | | | | | Example |
| B7 | A7 | One stage of | H₂ | 5 | 0.5 | 700 | 100 | Present | A | A | Present |
| | | circulating fluidized | | | | | | | | | Invention |
| | | bed + one stage of | | | | | | | | | Example |
| | | bubbling fluidized | | | | | | | | | |
| | | bed | | | | | | | | | |
| B8 | A8 | One stage of | H₂ | 5 | — | 700 | — | — | — | — | Comparative |
| | | circulating fluidized | | | | | | | | | Example |
| | | bed | | | | | | | | | |
| B9 | A9 | One stage of | H₂ | 5 | 0.5 | 700 | — | — | — | — | Comparative |
| | | circulating fluidized | | | | | | | | | Example |
| | | bed + one stage of | | | | | | | | | |
| | | bubbling fluidized | | | | | | | | | |
| | | bed | | | | | | | | | |
| B10 | A10 | One stage of | H₂ | 5 | 0.5 | 700 | — | — | — | — | Comparative |
| | | circulating fluidized | | | | | | | | | Example |
| | | bed + one stage of | | | | | | | | | |
| | | bubbling fluidized | | | | | | | | | |
| | | bed | | | | | | | | | |
| B11 | A11 | One stage of | H₂ | 5 | 0.5 | 700 | 20 | Absent | B | E | Present |
| | | circulating fluidized | | | | | | | | | Invention |
| | | bed | | | | | | | | | Example |

TABLE 5

| | Reduction process | | | | | | | | | | |
|---|---|---|---|---|---|---|---|---|---|---|---|
| | | | Reducing gas | | | | | | | | |
| | | | | Flow velocity | | | | Presence | | | |
| | | | | (m/s) | | | Residence | or absence | | Reduction | |
| | Ore | | Gas | First | Second | Temperature | time | of dust | Yield | degree | |
| No. | powder | Fluidized bed | type | stage | stage | (° C.) | (min) | circulation | (%) | (%) | Note |
| B12 | A12 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B13 | A13 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B14 | A14 | — | — | — | — | — | — | — | — | — | Comparative |
| | | | | | | | | | | | Example |
| B15 | A15 | — | — | — | — | — | — | — | — | — | Comparative |
| | | | | | | | | | | | Example |
| B16 | A16 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B17 | A17 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B18 | A18 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B19 | A19 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B20 | A20 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B21 | A21 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B22 | A22 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B23 | A23 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B24 | A24 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B25 | A25 | One stage of circulating | H₂ | 5 | 0.5 | 700 | 100 | Present | D | A | Present |
| | | fluidized bed + one stage | | | | | | | | | Invention |
| | | of bubbling fluidized bed | | | | | | | | | Example |
| B26 | A26 | One stage of circulating | H₂ | 5 | 0.5 | 700 | 100 | Present | C | A | Present |
| | | fluidized bed + one stage | | | | | | | | | Invention |
| | | of bubbling fluidized bed | | | | | | | | | Example |
| B27 | A27 | One stage of circulating | H₂ | 5 | 0.5 | 700 | 100 | Present | D | A | Present |
| | | fluidized bed + one stage | | | | | | | | | Invention |
| | | of bubbling fluidized bed | | | | | | | | | Example |
| B28 | A28 | One stage of circulating | H₂ | 5 | 0.5 | 700 | 100 | Present | F | A | Present |
| | | fluidized bed + one stage | | | | | | | | | Invention |
| | | of bubbling fluidized bed | | | | | | | | | Example |

TABLE 6

| | Reduction process | | | | | | | | | | |
|---|---|---|---|---|---|---|---|---|---|---|---|
| | | | Reducing gas | | | | | | | | |
| | | | | Flow velocity | | | | Presence | | | |
| | | | | (m/s) | | | Residence | or absence | | Reduction | |
| | Ore | | Gas | First | Second | Temperature | time | of dust | Yield | degree | |
| No. | powder | Fluidized bed | type | stage | stage | (° C.) | (min) | circulation | (%) | (%) | Note |
| B29 | A29 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B30 | A30 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B31 | A31 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B32 | A32 + 70 | One stage of circulating | H₂ | 5 | 0.5 | 700 | 100 | Present | A | A | Present |
| | μm sinter | fluidized bed + one stage | | | | | | | | | Invention |
| | feed | of bubbling fluidized bed | | | | | | | | | Example |
| | (pisolite ore) | | | | | | | | | | |
| B33 | A33 | One stage of circulating | H₂ | 5 | 0.5 | 700 | 100 | Present | B | A | Present |
| | | fluidized bed + one stage | | | | | | | | | Invention |
| | | of bubbling fluidized bed | | | | | | | | | Example |
| B34 | A34 | One stage of circulating | H₂ | 5 | 0.5 | 700 | 100 | Present | A | D | Present |
| | | fluidized bed + one stage | | | | | | | | | Invention |
| | | of bubbling fluidized bed | | | | | | | | | Example |
| B35 | A35 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B36 | A36 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |
| B37 | A37 | One stage of circulating | H₂ | 5 | 0.5 | 700 | 100 | Present | A | A | Present |
| | | fluidized bed + one stage | | | | | | | | | Invention |
| | | of bubbling fluidized bed | | | | | | | | | Example |

As shown in Tables 1 to 6, examples are shown in which the fine powder ore and the powdered iron ore including the fine powder ore could be reduced at a high yield by the granulation process of granulating the raw material fine powder containing iron and having a median diameter of 50 μm or less into the granular powder in the fluidized bed formed by fluidizing the medium particles and the reduction process of reducing at least the granular powder in the fluidized bed formed by fluidizing the granular powder.

As shown in Examples Nos. B1 and B11, by providing the granular powder obtained by granulating the raw material fine powder of magnetite concentrate in the fluidized bed formed by supplying the air in the granulation process for the reduction process, the magnetite concentrate could be reduced at a high yield and a high reduction degree.

As shown in Example No. B2, even in a case where pellet feed (hematite ore) was used as the raw material fine powder, the raw material fine powder could be reduced at a high yield and a high reduction degree.

Examples Nos. B3 to B5 are examples in which the dust was circulated, the fluidized bed and the residence time were changed, and other conditions were the same. It was found that the reduction degree was further improved by providing multiple stages of the fluidized bed.

Example No. B6 is an example in which the dust was circulated, and other conditions were the same as those of No. B3. It was found that a higher yield could be obtained by circulating the dust.

Examples Nos. B7 and B16 to B20 are examples in which types of the medium particles were changed, and other conditions were the same. In all of the examples, the medium particles that did not thermally decompose were used, and the raw material fine powder could be reduced at a high yield and a reduction degree.

On the other hand, in Examples Nos. B8 to B10 in which the granulation process was not performed, since the raw material fine powder was singly injected into the reduction apparatus, fluidization and handling were difficult, and stable processing and discharge of the reduced iron were difficult due to poor fluidization in the bubbling fluidized bed and staying and clogging in a downcomer portion of the circulating fluidized bed. Therefore, in Examples Nos. B8 to B10, reduced iron after the processing could not be obtained and the yield could not be calculated, so that the yield and the reduction degree were not calculated. That is, it can be said that in Examples Nos. B8 to B10, the reduction by the fluidized bed could not be performed.

Examples Nos. B12 to B13 are examples in which the median diameter of the raw material fine powder was changed, and other conditions were the same as those of No. B7. It was found that when the median diameter of the raw material fine powder was 50 μm or less, the raw material fine powder could be reduced at a high yield and a high reduction degree.

In Examples Nos. B14 to B15, the median diameter of the raw material fine powder was more than 50 μm, particulate fluidization was difficult. Furthermore, when agglomeration had started in the granulation vessel, the granular powder became excessively large, so that the granular powder could not be extracted by stopping the fluidization, and the reduction process was not performed.

In addition, when Examples Nos. B21 to B25 with different median diameters of the medium particles were compared to each other, in Example No. B25 in which the median diameter of the medium particles was larger than the median diameter of the raw material fine powder, the flow velocity at which the medium particles were fluidized became relatively fast, and dissipation of the raw material fine powder from the granulation vessel increased. As a result, Examples Nos. B21 to B24 with smaller median diameters of the medium particles had a higher yield than that of Example No. B25.

In addition, when Examples Nos. B7 and B26 to B28 with different volume ratios of the raw material fine powder were compared to each other, as the volume ratio of the raw material fine powder decreases, the ratio of the raw material fine powder that dissipated together with the gas from the granulation vessel tended to decrease, so that the yield was improved.

In Example No. B31 in which the particle size of the granular powder was increased to 0.18 mm, the difference in particle size between the granular powder and the medium particles was small, and it was somewhat difficult to separate the medium particles and the granular powder extracted from the granulation vessel from each other.

In Example No. B32, as the ore powder to be reduced by the reduction apparatus, in addition to the granular powder granulated in the granulation vessel, ore (sinter feed: pisolite ore) having a particle size median diameter of 70 μm exhibiting a fluidizable property was used, so that the powdered iron ore could be reduced at a high yield similarly to the other examples.

Example No. B33 is an example in a case where the pressure loss in the granulation process was not monitored, in which an abnormality in the pressure loss could not be detected at an early stage when the granules in the granulation process grew abnormally, some granules adhered to the granulation vessel and caused a slight decrease in yield, and there were cases where it took time to perform maintenance to remove deposits granulated abnormally at an apparatus stop timing.

Example No. B34 is a case where the internal shape of the granulation vessel was not the tapered shape in which the cross-sectional area of the upper portion was side, but a straight body shape having the same cross-sectional area. In this case, some of the raw material fine powder blown up in the granulation vessel was discharged from the vessel, resulting in a decrease in yield.

Example No. B11 is an example in which the magnetic separation and the dry sieve were used for separating the granules from the granulation vessel, Example No. B35 is an example in which the pneumatic classification was used, Example No. B36 is an example in which the magnetic separation and pneumatic classification were used, and Example No. B37 is an example in which sedimentation separation was used. In each of the examples, as in the case of the dry sieve, the granules could be separated from the raw material fine powder and the medium particles.

### INDUSTRIAL APPLICABILITY

As described above, according to the present invention, the hardly fluidizable fine powder ore and the powdered iron ore including the hardly fluidizable fine powder ore can be reduced using the fluidized bed at a high yield. The reduced iron obtained by the reduction can be melted and refined in an electric furnace and used as an iron source for the production of crude steel in the same manner as scrap and ordinary direct reduced iron (DRI) products. In addition, in a case where a process with a low attained reduction degree is designed, the reduced iron can be used as an iron source to be injected into a blast furnace as semi-reduced iron that lowers a usage rate of reducing materials in the blast furnace.

### BRIEF DESCRIPTION OF THE REFERENCE SYMBOLS

10, 10A, 10B, 10C, 10D Granulation apparatus
20 reduction apparatus
110, 110A, 110B, 110C, 110D Granulation vessel
111 Gas supply port
112 Raw material fine powder supply port
113 Distributor
114 Outlet
120 Dry dust collector
121 Valve
130 Granular powder separation device
140 Transporting device
141 Overflow pipe
142, 143, 144 Downcomer
150 Pressure measuring device
160 Screw feeder
161 First supply pipe
162 Second supply pipe
163 Lance
164 Downcomer
165 Supply pipe
166 Trickle valve
170 Vessel
171 Valve
200 Circulating fluidized bed reduction apparatus
210 Riser portion
211 Gas supply port
212 Ore powder supply port
213 Distributor
214 Outlet
220 Cyclone
230 Circulation line
231 Downcomer
232 Loop seal portion
240 Dry dust collector
250 Feeding device
300 Bubbling fluidized bed reduction apparatus
310, 310A Reactor
311 Gas supply port
312 Ore powder supply port
313 Distributor
314 Outlet
315 Partition plate
320, 320A, 320B Dry dust collector
400 Particulate fluidized bed
401 Medium particle
402 Bubble (gas, off-gas, supply gas)
403 Raw material fine powder
404 Granular powder
405 Dust
406 Reduced iron
500 Bubbling fluidized bed
501 Ore powder
502 Bubble (gas, off-gas, supply gas)
1102, 1102A, 1102B, 1102C, 1102D Freeboard portion

1. A facility for producing reduced iron comprising:
a granulation apparatus that granulates raw material fine powder that contains iron and has a median diameter of 50 μm or less into granular powder in a fluidized bed formed by fluidizing medium particles that do not thermally decompose during fluidization; and
a reduction apparatus that reduces at least the granular powder in a fluidized bed formed by fluidizing the granular powder.

2. The facility for producing reduced iron according to claim 1,
wherein the reduction apparatus includes one or more circulating fluidized bed reduction apparatuses for forming a circulating fluidized bed or one or more bubbling fluidized bed reduction apparatuses for forming a bubbling fluidized bed or combination thereof.

3. The facility for producing reduced iron according to claim 1,
wherein the reduction apparatus includes a collecting device that collects dust including at least fine particles of partially unreduced iron ore.

4. The facility for producing reduced iron according to claim 3,
wherein the reduction apparatus includes a feeding device that feeds the dust collected by the collecting device to a granulation vessel of the granulation apparatus.

5. The facility for producing reduced iron according to claim 1,
wherein the medium particles included in the granulation apparatus include a carbide, an oxide, a nitride, or any combination thereof having a melting point of higher than 1,200° C.

6. The facility for producing reduced iron according to claim 1,
wherein the granulation apparatus includes a mechanism for measuring a pressure loss in the fluidized bed.

7. The facility for producing reduced iron according to claim 1,
wherein the granulation apparatus includes a granular powder separation device that separates the granular powder from the fluidized bed, and
the granular powder separation device includes a mechanism of magnetic separation, dry sieving, pneumatic classification, or sedimentation classification, or any combination thereof.

8. The facility for producing reduced iron according to claim 1,
wherein, in a granulation vessel in which the fluidized bed is formed, a maximum cross-sectional area of a horizontal cross section in a freeboard portion provided above the fluidized bed of the granulation vessel is larger than a cross-sectional area of a horizontal cross section in a region in which the fluidized bed is disposed.

9. The facility for producing reduced iron according to claim 1,
wherein, in a granulation vessel in which the fluidized bed is formed, a maximum cross-sectional area of a horizontal cross section in a freeboard portion provided above the fluidized bed is larger than a cross-sectional area at which a gas superficial velocity in the freeboard portion becomes a terminal velocity of the raw material fine powder.

10. The facility for producing reduced iron according to claim 1,
wherein the reduction apparatus includes a pipe for supplying the granular powder to an inside of the reduction apparatus, and
the reduction apparatus and the granulation apparatus are connected to each other by the pipe.

11. A method for producing reduced iron comprising:
granulating raw material fine powder that contains iron and has a median diameter of 50 μm or less into granular powder in a fluidized bed formed by fluidizing medium particles that do not thermally decompose during fluidization; and
reducing at least the granular powder in a fluidized bed formed by fluidizing the granular powder.

12. The method for producing reduced iron according to claim 11,
wherein, in the reducing, one or more circulating fluidized bed reaction vessels, one or more bubbling fluidized bed reaction vessels, or one or more circulating fluidized bed reaction vessels and one or more bubbling fluidized bed reaction vessels are used.

13. The method for producing reduced iron according to claim 11,
wherein, in the reducing, dust including at least fine particles of partially unreduced iron ore is collected.

14. The method for producing reduced iron according to claim 13,
wherein the dust collected in the reducing is used in the granulating.

15. The method for producing reduced iron according to claim 11,
wherein the medium particles used in the granulating include a carbide, an oxide, a nitride, or any combination thereof having a melting point of higher than 1,200° C.

16. The method for producing reduced iron according to claim 11,
in the granulating, a pressure loss in the fluidized bed is measured.

17. The method for producing reduced iron according to claim 11,
wherein, in the granulating, the granular powder is separated from the fluidized bed, and
the separation of the granular powder is performed by magnetic separation, dry sieving, pneumatic classification, or sedimentation classification, or any combination thereof.

18. The method for producing reduced iron according to claim 11,
wherein, in a granulation vessel in which the fluidized bed is formed, a maximum cross-sectional area of a horizontal cross section in a freeboard portion provided above the fluidized bed of the granulation vessel is larger than a cross-sectional area of a horizontal cross section in a region in which the fluidized bed is disposed.

19. The method for producing reduced iron according to claim 11,
wherein a maximum cross-sectional area of a horizontal cross section in a freeboard portion provided above the fluidized bed formed in the granulating is larger than a cross-sectional area at which a gas superficial velocity in the freeboard portion becomes a terminal velocity of the raw material fine powder.

20. The method for producing reduced iron according to claim 11,
wherein a granulation apparatus that granulates the raw material fine powder that contains iron and has a median diameter of 50 μm or less into the granular powder in the fluidized bed formed by fluidizing the medium particles that do not thermally decompose during fluidization and a reduction apparatus that reduces the granular powder are connected to each other, and
the granular powder is supplied to the reduction apparatus via a pipe provided in the reduction apparatus.
